(19) United States
(12) Patent Application Publication
(10) Pub. No.: US 2003/0229476 A1
(43) Pub. Date: Dec. 11, 2003

(54) Enhancing dynamic characteristics in an analytical model

(75) Inventors: Basavapatna P. Naganarayana, Farmington, MI (US); Sathyanarayana Shankar, Bloomfield Hills, MI (US); Viswanath S. Bhattachar, Novi, MI (US)

Correspondence Address: RADER, FISHMAN & GRAUER PLLC, 39533 WOODWARD AVENUE, SUITE 140, BLOOMFIELD HILLS, MI, 48304-0610, US

(73) Assignee: Lohitsa, Inc.

(21) Appl. No.: 10/164,813

(22) Filed: Jun. 7, 2002

(51) Int. Cl. G06F 17/50

(52) U.S. Cl. 703/1

(57) ABSTRACT

The enhancement of dynamic characteristics relating to a structural design represented by an analytical model such as a conventional finite element model. Embedded intelligence and predetermined rules alleviate the need to undergo a “brute force” analysis at every model location for all potential characteristics. A subset of interesting locations can be identified using characteristics relating to those locations. Component and fastener locations can be enhanced. Durability, strength, degradation criteria, neighborhood analysis, and other fastener characteristics can be analyzed and enhanced. Sensitivity, energy, stress, and other component characteristics can be analyzed and enhanced. The dynamic characteristics of spot-weld layouts and design enhancements can be enhanced, improving the performance of a product, while expanding the life of the product at the same time. Manufacturing personal can use critical fastener data to ensure that these fasteners are not omitted due to manufacturing process instabilities, thus ensuring a quality product.

### BACKGROUND OF THE INVENTION

The present invention relates to a method or system for enhancing the static and/or dynamic characteristics (e.g. modal shapes/frequencies, energy distribution, structural sensitivity, transient responses, stress distribution, fastener layout, and other criteria and characteristics collectively referred to as “characteristics”) of component locations and/or fastener locations in a physical assembly represented by an analytical model. More specifically, the invention provides an analytical approach for enhancing component characteristics and/or fastener characteristics embodied in the model by reducing mass, improving durability, improving load distribution, changing structural parameters, and other methods for enhancing the characteristics of components and/or fasteners.

The demands of the 21^{st} century marketplace require ever increasing functionality, reliability, sophistication, and quality with respect to manufactured products and other forms of structures. While performance demands are increasing, cost pressures require manufacturers to do more than they did before, at a lower cost. The conflicting tension between lowering costs and increasing performance requirements are prevalent in a wide variety of different industries, including the automotive, aerospace, robotics, industrial tooling, and other industries.

To meet the manufacturing challenges of the 21^{st} century, it would be beneficial to enhance structural designs using primarily analytical modeling. Prior art techniques rely heavily on physical testing and other non-analytical techniques. However, physical testing and other non-analytical approaches are expensive, time consuming, and often fail to suggest the true cause of an undesirable structural characteristics. Physical testing will often result in too little information, in too late a time frame. A physical test often requires the actual manufacture of many assemblies for testing, so resulting design changes can only be made in the later stages of the product development and design process, a point in time when changes are highly expensive and extremely inconvenient.

Time and expense issues aside, physical testing suffers from other significant limitations. Structures often involve a potentially voluminous number of assemblies, parts, and elements. Design problems at internal locations are often not externally identifiable, and thus the true causes of problems can be difficult to discover. Several iterations of testing may be required before such characteristics can be identified with adequate specificity. This is especially true when conducting a physical test in actual conditions, such as a road test for automobiles.

Prior art tools in product design include computer-aided engineering tools using finite element solvers, finite element modelers, and finite element processors (collectively “finite element analyzers”) for product development. It is desirable for design enhancement tools to be capable of interfacing with existing cost-effective tools such as finite element analyzers, while expanding upon the functionality that such tools provide.

It is also desirable for an enhancement system to apply intelligence in the form of predefined rules and processes in order to prevent an analytical “brute force” attempt at problem solving. It is rarely (if ever) possible to evaluate all of the possible permutations relating to a design of even medium complexity. Finite element models can include hundreds of thousands of data points, with an even greater number of relationships between all of those data points. A “brute force” analytical solution cannot provide a practical answer to the model enhancement needs of industry. In contrast, the application of an approach utilizing embedded intelligence can result in substantial performance enhancements in a real-time development environment.

### SUMMARY OF INVENTION

The present invention relates to a method or system (“enhancement system” or simply “system”) used to enhance the dynamic characteristics of an analytical model. The invention uses embedded intelligence and/or predefined rules to avoid the time and resource constraints involved with a “brute force” analytical solution, e.g. the checking all possible design iterations and the performing of voluminous mathematical operations to determine an “optimal” solution.

The enhancement system can incorporate many different subsystems. One such subsystem is the dynamic characteristics enhancement subsystem (the “enhancement subsystem”). The enhancement subsystem can identify a subset of locations such as parts, zones, joints, assemblies, fasteners, and other locations (collectively “locations”) in an analytical model that are “interesting” from a potential enhancement perspective. A wide variety of characteristics relating to a particular location in the model can be used in the determination of whether a particular location is an “interesting” location. One or more characteristics at one or more interesting locations can be enhanced by the enhancement subsystem.

The enhancement subsystem can be used to enhance model locations relating to fasteners, as well as model locations that do not relate to fasteners. In a preferred embodiment of the invention, both fastener and non-fastener (e.g. component) locations are eligible for enhancement. A fastener enhancement subsystem can be used to perform processing relating to the analysis and enhancement of fastener locations and characteristics. A component enhancement subsystem can be used to perform processing relating to the analysis and enhancement of parts, elements, assemblies, and other design compartmentalization categories (collectively “components”).

The fastener enhancement subsystem can analyze, select, and enhance fasteners with respect to a wide variety of characteristics, including their layout (“neighborhood analysis”), degradation criteria, life (“durability”) criteria, strength (“failure”) criteria, and other related fastener criteria and fastener characteristics (collectively “fastener characteristics”).

A wide variety of characteristics can be analyzed and enhanced by the component enhancement subsystem. Modal solutions, energy distribution, structural sensitivity, transient responses, stress distribution, and other component criteria and component characteristics (collectively “component characteristics”) can be used by the component enhancement subsystem to identify “interesting” locations and enhance the characteristics at those locations.

A preferred embodiment of the invention includes a highly flexible and automated user interface to maximize the ability of a user to set processing parameters, while at the same time fully utilizing the intelligence embedded in the system to configure display and reporting functions to focus on areas and aspects that experienced engineers and designers would focus on.

When desirable, some embodiments the system can compare and rank various models with respect to different characteristics. “What if” analysis can be performed with regards any aspect of the system.

The foregoing and other functionality and features of the invention will be more apparent from the following description when taken in connection with the accompanying drawings.

### BRIEF DESCRIPTION OF THE DRAWINGS

FIG. 1 is a partial environmental view of an embodiment of the invention, illustrating that the invention can manipulate analytical models representing physical objects.

FIG. 2 is a block diagram illustrating an example of the relationships between locations, interesting locations, and critical locations.

FIG. 3 is a block diagram illustrating some examples of component locations and fastener locations.

FIG. 4 is data diagram illustrating an example of the different potential models that can be incorporated into the system.

FIG. 5 is a high-level flow chart illustrating some of the various subsystems that can be used in a preferred embodiment of the invention.

FIG. 6 is a subsystem-level flow chart illustrating some examples of the modules that can be incorporated into the various subsystems.

FIG. 7 is a flow chart illustrating one example of an overall process flow of the invention, including many of the various modules that can be incorporated into the system.

FIG. 8 is a flow chart illustrating an example of the processing performed by a model input/output module.

FIG. 9 is a flow chart illustrating an example of the processing performed by a create model module.

FIG. 10 is a flow chart illustrating an example of the processing performed by a create/enhance fastener locations module.

FIG. 11 is a flow chart illustrating an example of the processing performed by a build fastener database references module.

FIG. 12 is a flow chart illustrating an example of the processing performed by a create component locations module.

FIG. 13 is a flow chart illustrating an example of the processing performed by a create zones module.

FIG. 14 is a flow chart illustrating an example of the processing performed by a create joints module.

FIG. 15 is a flow chart illustrating an example of the processing performed by an energy analysis module.

FIG. 16 is a flow chart illustrating an example of the processing performed by an energy analysis module with respect to a specified location.

FIG. 17 is a flow chart illustrating an example of the processing performed by a stress analysis location.

FIG. 18 is a flow chart illustrating an example of the processing performed by a stress analysis module with respect to a specified location.

FIG. 19 is a flow chart illustrating an example of the processing performed by a sensitivity analysis module.

FIG. 20 is a flow chart illustrating an example of the processing performed by a sensitivity analysis module with respect to a specified location.

FIG. 21 is a flow chart illustrating an example of the processing performed by a component enhancement subsystem.

FIG. 22 is a flow chart illustrating an example of the process performed by a fastener enhancement subsystem.

FIG. 23 is a flow chart illustrating an example of the processing performed by a fastener location evaluation module.

FIG. 24 is a flow chart illustrating an example of the processing performed by a build fastener areas module.

FIG. 25 is a flow chart illustrating an example of the processing performed by a fastener neighborhood analysis module.

FIG. 26 is a flow chart illustrating an example of the processing performed by a compute fastener area failure stresses module.

FIG. 27 is a flow chart illustrating an example of the processing performed by a compute effective fastener stress module.

FIG. 28 is a flow chart illustrating an example of the processing performed by a compute effective continuum stress module.

FIG. 29 is a flow chart illustrating an example of the processing performed by a compute fastener area failure life module.

FIG. 30 is a flow chart illustrating an example of the processing performed by a sort fasteners and components module.

FIG. 31 is a flow chart illustrating an example of the processing performed by a fastener degradation evaluation module.

FIG. 32 is a flow chart illustrating an example of the processing performed by a fastener enhanced evaluation module.

### DETAILED DESCRIPTION OF PREFERRED EMBODIMENTS

I. Overview of the Method and System

The inventive system and method (collectively “the system”) provides the ability to enhance the static and dynamic characteristics of an analytical model representing a physical structure. The system does not require the existence of physical structure in order for an analytical model to be evaluated and enhanced. In a preferred embodiment, analytical models are created, analyzed, enhanced, and compared with models before a physical structure is created. “Intelligence” embedded in the system can be applied in an automated manner, identifying a number of locations on the model as “interesting” locations with respect to one or more characteristics relating to the particular location. Those locations can then be set with enhanced characteristics in an enhanced model. Various enhanced models and non-enhanced models can be compared with each other to facilitate the selection of enhancements that provide the most significant improvements in the static and dynamic characteristics of the model. The system can support an analysis using a wide variety of different model characteristics that relate to and represent characteristics of a physical structure, such as modal shapes/frequencies, stress distribution, energy distribution, structural sensitivity, transient responses, fastener layout, and other characteristics (collectively “characteristics”) discussed below.

By providing an analytical framework that does not rely on analytical “brute force,” the system can facilitate design improvements, such as the reduction of structural mass in the physical structures that can be built using enhanced models generated by the system. Use of the system can facilitate a reduction in failure rates relating to a physical structure and its fasteners can be reduced. Structural characteristics such as strength and durability can be enhanced. Part parameters (such as thickness and other part characteristics) and fastener layout can be enhanced with the system, allowing a user to substantially enhance the performance of a particular physical structure while making efficient use of the resources needed to manufacture the structure.

A. Environmental View

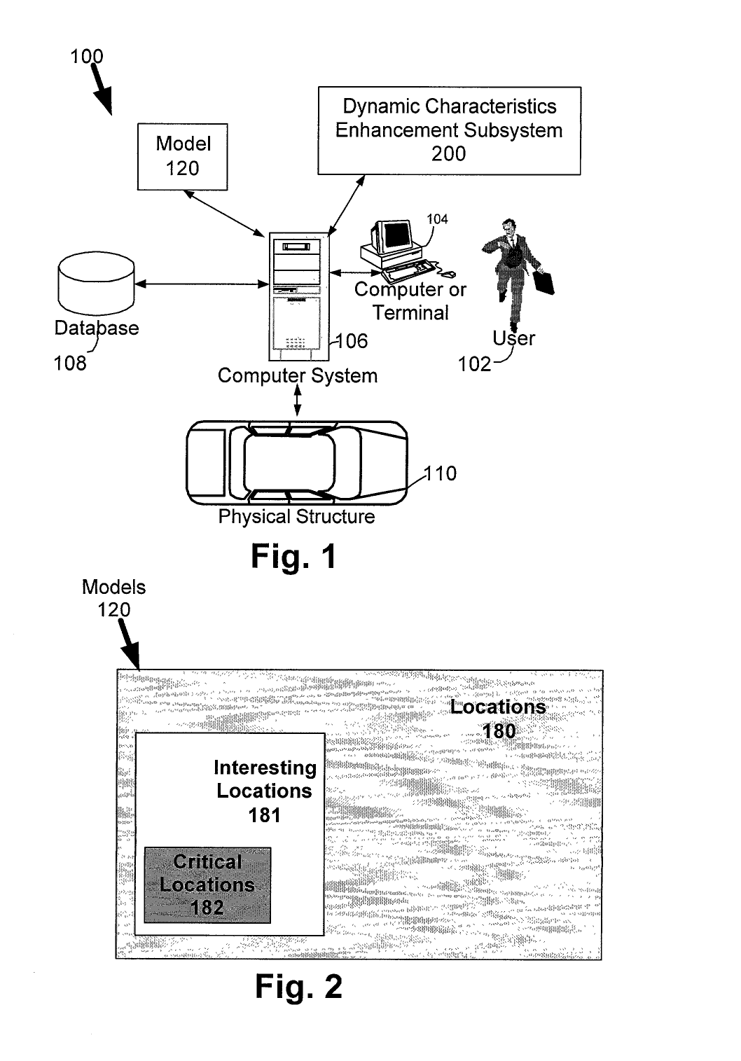

FIG. 1 discloses a high-level partial environmental view of a system for enhancing the dynamic and static characteristics (“an enhancement system” 100 or simply the “system” 100) relating to a model 120. The system 100 allows a user 102 to enhance the static and dynamic characteristics of an analytical model 120 representing a presently existing or potential future physical structure 110. At the time that a model 120 is being created, analyzed, enhanced, or subject to other processing, the physical structure 110 need not exist in order for the system 100 to function. In a preferred embodiment, the analytical tools and functions provided by the system 100 are used before the creation of any physical structures 110.

A computer 104 and/or a computer system 106 facilitate the ability of the user 102 to interact with the various models 120 used and processed by the system 100. The computer or computer terminal (collectively the “computer”) 104 can be potentially any device capable of running software or communicating with a device capable of running software. In some preferred embodiments, the computer 104 is a work station connected to a network, intranet, extranet, or similar configuration (collectively the “computer system”) 106. In alternative embodiments, the computer 104 can be a personal data assistant, a cell phone, a personal desktop computer, a laptop computer, an embedded computer device, or any other device capable of running a computer program, or capable of communicating with a device that is capable of running a computer program. In some embodiments, the computer 104 and the computer system 106 are the same device, such as a desktop computer or work station that is not connected to a network or similar configuration.

The computer system 106 can be used to read, create, manipulate, or analyze the analytical model 120, a design representing the physical structure 110. In a preferred embodiment, the computer system 106 includes a work station networked to other work stations and personal computers, with another networked work station running a conventional finite element solver, finite element modeler, or finite element processor (collectively “finite element analyzer” or “finite element solver”) in tandem with the system 100. In alternative embodiments, the computer system 106 can be any type of stand-alone or networked computer or any other device capable of performing functionality similar to that of a finite element analyzer.

Information that is relevant to the system 100 can be stored in a database 108. In a preferred embodiment of the invention, a single object-oriented database 108 is used to store relevant data. In alternative embodiments, multiple databases 108 may be used, and such database configurations may be relational, hierarchical, or employ one or more other database methodologies. If multiple databases are used, the system 100 will preferably include a model database, a component enhancement database, and a fasteners database. Alternative embodiments may utilize a wide range of different database configurations and structures. If processing on a particular model 120 needs to be interrupted, the system 100 can save all results on the database 108, and resume processing at the same point at which processing was interrupted. This avoids having to start the process from the beginning, saving time for the user 102 and for the system 100.

The system 100 can incorporate the functionality of a wide variety of subsystems, modules, functions, and process steps. A dynamic characteristics enhancement subsystem (the “enhancement subsystem”) 200 is one example of such a subsystem. A subsystem can incorporate the functionality of one or more different modules. A module can incorporate the functionality of one or more different functions and/or process steps. Although particular configurations of subsystems, modules, functions, and process steps can be preferred, the system 100 is highly flexible in the various combinations of processing that can be performed. Examples of subsystems, modules, functions, and process steps are disclosed in greater detail below.

B. Locations and Models

1. Interesting and Critical Locations

Like the physical assembly 110 it represents, a design embodied in a model 120 is comprised of a hierarchy of compartmentalized units called locations. FIG. 2 is a block diagram illustrating the relationship between a location 180, an interesting location 181, and a critical location 182. A model 120 is made up of many different locations 180. However, only a subset of all locations 180 are “interesting” from a potential enhancement point of view. Such locations are thus referred to as interesting locations 181. By focusing attention on interesting locations 181 instead of all locations 180, the system 100 can generate meaningful results in a real-time and potentially simultaneous manner. Generally, only a subset of interesting locations 181 are ultimately identified by the system 100 as critical locations 182. The system 100 can be configured to identify as few as one interesting location 181 to constitute a critical location 182. In some embodiments, the number of critical locations 182 is determined by the user 102 through the use of a user interface in the computer 104. In other embodiments, the number of critical locations 182 is determined by the system 100 using predefined rules, model classifications, physical structure classifications, historical data, and other information relating to the model 120. Locations 180 serve as an important building block in the model 120. The system 100 can support a wide variety of different types of locations 180 (e.g. location types). Examples of various locations types are described in greater detail below.

2. Location Types

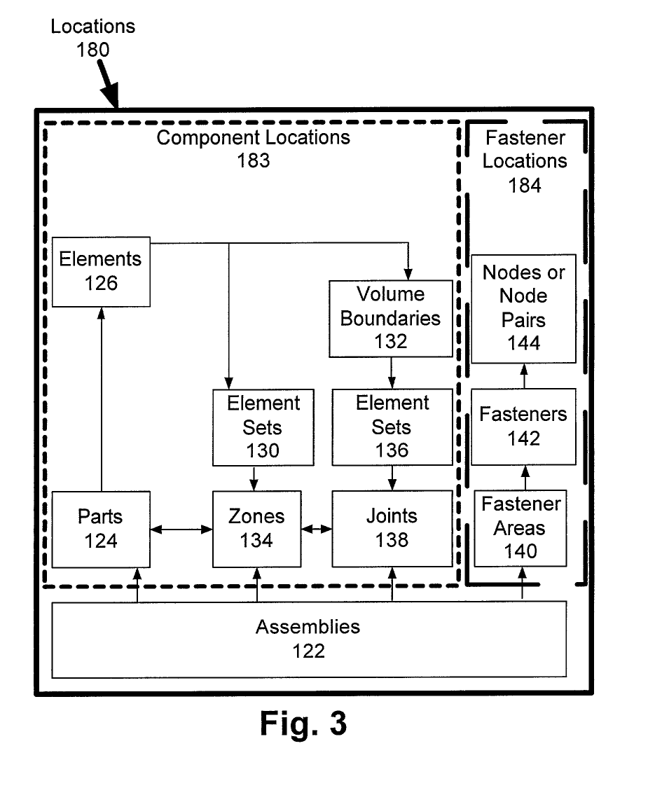

FIG. 3 is a block diagram illustrating some examples of different locations 180. Different embodiments of the system 100 can incorporate a wide variety of different location types. The block diagram in the figure illustrates many of the different types of locations 180. In a preferred embodiment, there are at least two general categories of locations 180, a component location 183 and a fastener location 184. Component locations 183 can include one or more assemblies 122, parts 124, elements 126, zones 134, zone element sets 130, joints 138, joint element sets 136, joint volume boundaries 132, and other types of component locations 183. In the figure, assemblies 122 are not considered a component location 183, but in a preferred embodiment, assemblies 122 are a type of component location 183. Fastener locations 184 can include one or more fastener areas 140, fasteners 142, and fastener element sets such as nodes and node pairs 144, and other types of locations 180. A fastener 142 can be a bolt, a weld (including spot welds, laser welds, and other types of welds), a spring, a nail, a screw, a rivet, a portion of adhesive, a snap, a zipper, or any other type of fastener or connector (collectively “fastener” 142). The area surrounding a particular fastener 142 is the fastener area 140 for that particular fastener 142.

In a preferred embodiment, the various locations 180 have hierarchical relationships with each other. Each model 120 can include one or more assemblies 122. Each assembly 122 can include one or more parts 124. Each part can include one or more elements 126. Fasteners 142 are any form of connector that are used to connect together any two or component locations 183 of a model 120. A fastener area 140 includes the fastener 142 and the surrounding area. The elements of a fastener 142 are nodes and/or node pairs 144. An element 126 is the smallest structural unit in a finite element model 120 that is capable of having structural characteristics. A joint 138 includes at least one element set 136, which is determined by at least one volume boundary 132. A zone 134 incorporates at least one element set 130. The distinctions between joints 138 and zones 134 are described in greater detail below. By targeting processing at the various hierarchical levels of parts 124, zones 134, joints 138, assemblies 122, and other location types, the system 100 avoids the computational “brute force” required to fully process all elements 126 and all element relationships in the model 120.

Characteristics of the model 120 include the characteristics relating to its assemblies 122, and the characteristics of the assemblies include the characteristics of their parts 124, and so on and so forth. Characteristics can relate to virtually any attribute of a model or one of its various sub-units. Many characteristics relate to terms of physics and mechanical engineering, such as mass, composition, shape, thickness, volume, surface area, stress, strain, energy, lifespan (durability), strength (resistance to failure), modal solutions, structural sensitivity, transient responses, neighborhood (proximity) analysis, and any other aspects, attributes, or characteristics that are desirable in enhancing static and dynamic characteristics (collectively “characteristics”). Characteristics that relate only to components can be referred to as component characteristics. Characteristics that relate only to fasteners can be referred to as fastener characteristics. Characteristics can be related to each with other, with certain characteristics being derived from one or more other characteristics, such as the processing performed to determine a weighted average.

3. Models

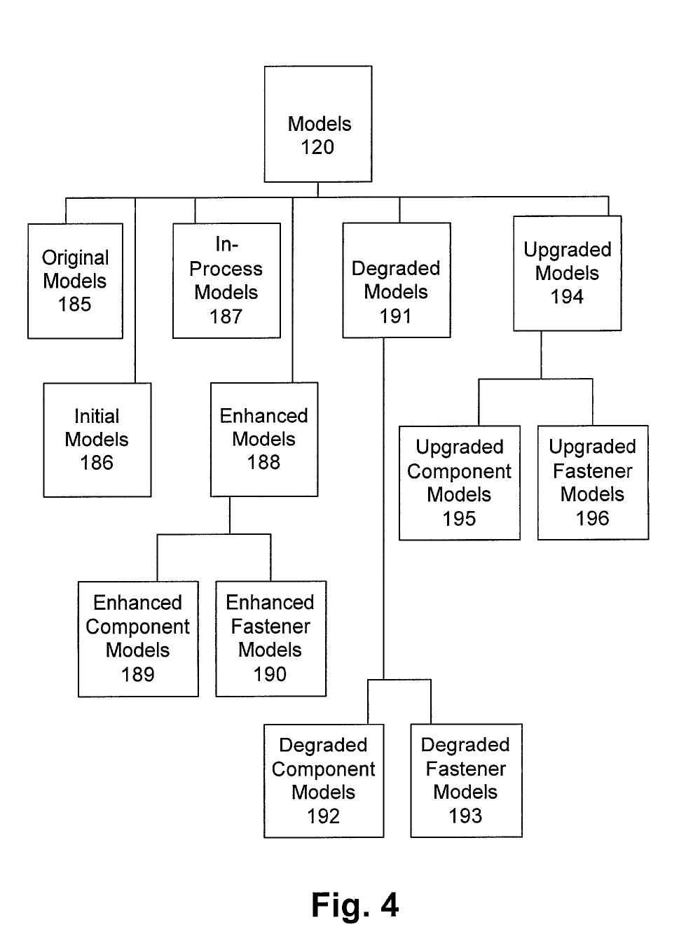

There are many different model types that can be supported by the system 100. FIG. 4 is a data hierarchy diagram illustrating some of the different types of models 120 that can be incorporated into the system 100, and some of the potential relationships between the various models 120. An original model 185 is typically an imported model that is not generated by the system 100, but instead is imported from a different source such a conventional finite element analyzer. In alternative embodiments, the system 100 incorporates the functionality of a conventional finite element analyzer, and generates the original model 185 from within the system 100. An initial model 186 is the result of an original model 185 being “cleaned” or “formatted” as described below. An initial model 186 is configured with the various locations 180 used as data tracking and evaluation mechanisms by the system 100. An in-process model 187 is a model that is being processed by the enhancement subsystem 200 that has not yet been transformed into an enhanced model 188. An enhanced model 188 is an initial model 186 with at least one enhanced characteristic for at least one location in the model 120. A model 120 can be enhanced with respect to: both fastener locations 184 and component locations 183; just fastener locations 184 (an enhanced fastener model 190); or just component locations 183 (an enhanced component model 189). A model 120 enhanced in any way can be referred to as an enhanced model 188.

In a preferred embodiment, the system 100 supports the comparisons of models 120 with each other. Characteristics can be enhanced or degraded, with the results being compared to other models 120. A degraded model 191 is a model 120 with degraded characteristics at one or more critical locations 182. A fastener degraded model 193 is a model 120 that has been degraded with respect to at least one fastener characteristic at a critical fastener location. A component degraded model 192 is a model 120 that has been degraded with respect to at least one component characteristic at least one critical component location. Correspondingly, an upgraded model 194 is a model with either restored or upgraded location characteristics at one or more critical locations 182. An upgraded model 194 can be fastener upgraded model 196, a component upgraded model 195, or both at the same time. As described below, the system 100 can interface with external finite element analyzers to optimize models 120 generated by the system 100. Such models can be referred to as optimized models. The optimization subsystem is described in greater detail below. An optimized model is an enhanced model that has been subject to processing by an optimization subsystem, described below.

As discussed both above and below, one important tool for generating an enhanced model 188 from an initial model 186 is the dynamic characteristics enhancement subsystem 200 (“enhancement subsystem” 200). The enhancement subsystem 200 performs the functionality of selectively identifying a subset of locations in the model 120 as “interesting” locations 181. Locations are identified as “interesting” with respect to one or more characteristics relating to the particular model location. The same characteristic(s) that makes a model location interesting can be enhanced in an enhanced model 188 derived from the initial model 186. The enhancement subsystem 200 is described in greater detail below.

II. Subsystem-Level View

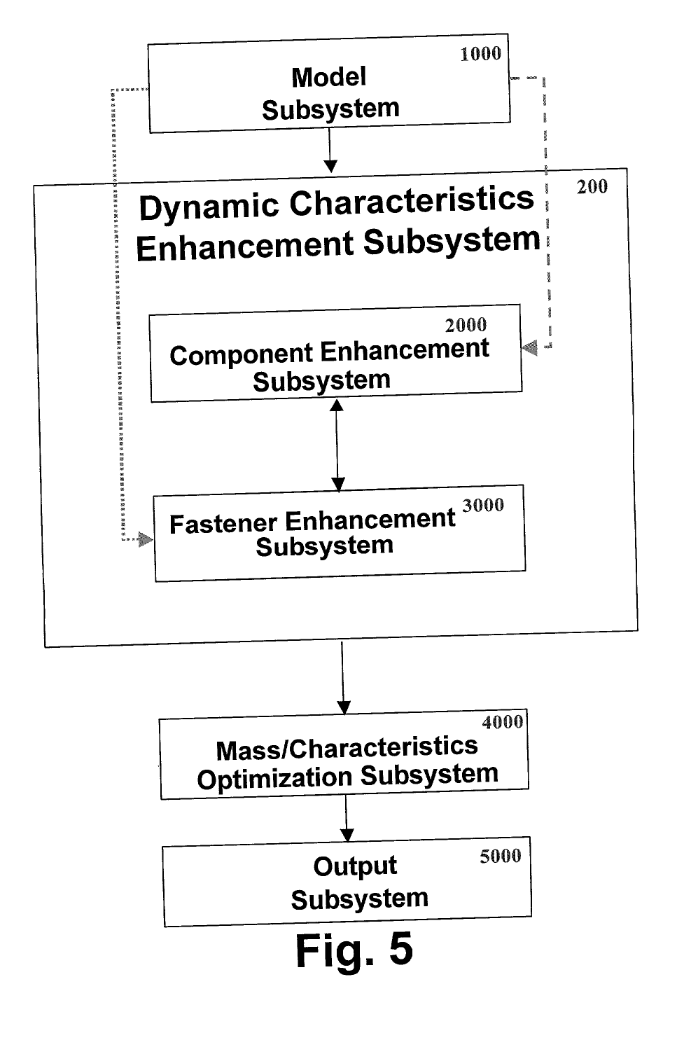

The system 100 can incorporate a wide variety of different subsystems in the performance of system functions. FIG. 5 discloses one example of some of the various subsystems that can be incorporated by the system 100.

A. Model Subsystem

A model subsystem 1000 is responsible for providing the system 100 with the initial model 186 in which to perform processing. The model subsystem 1000 generates, manipulates, and/or saves design information, in all of the various models 120 supported by the system 100. Model characteristics may include any information relating to a model 120, or the various sub-structures contained in a model 120 such as component locations 183, fastener locations 184, assemblies 122, parts 124, elements 126, fasteners 128, zones 134, zone element sets 130, joints 138, joint element sets 136, and joint volume boundaries 132. All model information to be saved may be saved on a model database 108. The model subsystem 1000 can include a wide variety of different modules to perform various functions, and some examples of such modules are described in greater detail below.

In some embodiments, the model subsystem 1000 “cleans” or “formats” a model created by a commercially available finite element analyzer (an “unprocessed model” or “original model” 185). This cleaning/formatting process is described in greater detail below. In other embodiments, the initial model 186 is created internally through the use of the model subsystem 1000. Regardless of the origin of the model 120, dynamic load information can be imported, built, displayed, processed, enhanced, and/or optimized in a wide variety of different formats, including a time-history format, a magnitude-phase format, a real-imaginary format, a power spectral density format, or other formats with their various characteristics.

The overarching function of the model subsystem 1000 is to provide the other subsystems of the system 100 with models 120 in a format that can be processed by the system 100. The model subsystem 1000 creates component locations 183 (which can also be called “design locations”) by binding volume (e.g. joints 138), by node/element sets (e.g. zones 134), by sets of parts (e.g. assemblies 122) or by any other locations types useful for tracking various structural characteristics such as energy, stress, design sensitivity and other component (e.g. design) characteristics. The model subsystem 1000 can also create node and element sets 184 for tracking the various structural response parameters and other characteristics in the vicinity of fasteners to track force and stress at fastener areas 140 (a type of fastener location 184). In a preferred embodiment, fastener areas 140 are used to track fastener characteristics and component locations 183 (e.g. design locations) are used to track component (e.g. design) characteristics. As discussed below, a wide variety of different processes can be used to setup the locations 180 used by the system 100. The system 100 can incorporate a wide range of different location types 180, and a wide variety of different location types 180 in the same model 120.

B. Dynamic Characteristics Enhancement Subsystem

The dynamic characteristics enhancement subsystem 200 (the “enhancement subsystem” 200) receives as input an initial model 186 that has either been created or cleaned/prepared for subsequent processing, by the model subsystem 1000. A model 120 that has been passed along by the model subsystem 1000 to the enhancement subsystem 200 has been embedded with mechanisms such as fastener locations 184 and component locations 183 (and other location types 180) that permit the effective tracking of model characteristics useful for the enhancement process.

The enhancement subsystem 200 selectively identifies one or more “interesting” locations 181 from the various locations in the model 120. The subset of interesting locations 181 can be selected on the basis of one or more characteristics relating to that model location 180 and characteristics. Thus, a model location 180 may be interesting with respect to one type of characteristic, while not constituting an interesting location 181 with respect to another characteristic. Some or all of the interesting locations 181 can be enhanced by the enhancement subsystem 200, and one or more critical locations 182 can be selectively identified from the subset of interesting locations 181. A particular location 180 may be a critical location 182 with respect to a particular characteristic while not constituting a critical location 182 with respect to other characteristics. The enhancement subsystem 200 can compare various enhanced models 188 in order to identify critical locations 182 in the model 120. At an enhanced model location 180, the initial characteristics for that location are reset by the system 100 as enhanced characteristics.

As discussed above, there are two primary categories of model locations 180. One type relates to fasteners locations 184, and the other type relates to non-fasteners (component or design) locations 183. Fasteners 142, as identified above, can be any form of a connector between elements 126, parts 124, assemblies 122, joints 138, zones 134, etc. Fastener locations 184 have fastener characteristics, such as fastener type, node pairs, etc. Non-fastener locations 183 can be referred to as design locations 183 or component locations 183, and their characteristics are determined by the characteristics of the various underlying elements and locations. Component locations 183 have component characteristics. Component characteristics are based on the characteristics of the element 126, part 124, assembly 122, joint 138, zone 134, etc. Due to physical differences between non-fastener locations 183 and fastener locations 184, different characteristics are typically relevant for enhancement purposes. Thus, in a preferred embodiment, the enhancement subsystem 200 includes a component enhancement subsystem 2000 and a fastener enhancement subsystem 3000. The component enhancement subsystem 2000 can also be referred to as a part design subsystem 2000. In alternative embodiments of the system 100, both subsystems need not be present. In a preferred embodiment of the system 100, both subsystems are present, and it does not generally matter which subsystem is invoked before the other.

1. Component Enhancement Subsystem

The component subsystem 2000 (also known as a part design subsystem 2000) preferably focuses on characteristics such as energy, sensitivity, and stress. Alternative embodiments can focus on different characteristics, fewer characteristics, or a greater number of characteristics.

Either the user 102 or the system 100 (through predefined defaults and rules, historical information, and/or embedded intelligence) determines various component characteristic constraints. Structural rigidity/stiffness of the most stress-sensitive, energy-sensitive, and design-sensitive parts are enhanced at the most sensitive locations. Similarly, rigidity/stiffness can then be reduced at less sensitive locations. Solving the resulting model 120 with the standard or default load input response characteristics, both dynamic response characteristics and static response characteristics are generated. All characteristics can be checked to see if constraint targets have been satisfied. If not, the list of critical locations 182 may be accessed to determine which location requires subsequent enhancement. Model comparisons can be performed to assess the dynamic characteristics of any enhanced models.

The component enhancement subsystem (e.g. part design enhancement subsystem) 2000 can use a wide variety of different modules to perform processing. The various potential modules of the part design enhancement subsystem 2000 are described below.

2. Fastener Enhancement Subsystem

The fastener enhancement subsystem 3000 preferably focuses on characteristics such as durability (lifespan), strength (non-failure), and degradation issues in the vicinity or fastener area 140 (e.g. neighborhood) of the fasteners 142. Alternative embodiments can focus on different characteristics, fewer characteristics, or a greater number of characteristics.

Interesting and/or critical fasteners locations 184 should be identified for subsequent enhancement by the subsystem 3000. The positive influence of the critical fasteners on the structural characteristics should be established through one or more degradation evaluations. Similarly, the layout of the fastener locations 184 should be enhanced with respect to characteristics. The system 100 can facilitate a reduction in the number of fasteners 142 used in the model 120. The enhanced model 120 should then be accessible to other aspects of the system 100, including the enhanced part design subsystem 2000.

The fastener enhancement subsystem 3000 can use a wide variety of different modules to perform processing. The various potential modules of the fastener enhancement subsystem 3000 are described below.

C. Optimization Subsystem

An optimization subsystem 4000 takes one or more of the enhanced models 188 generated by the enhancement subsystem 200 and performs additional optimization. A “full fledged” optimization on the enhanced model 120 with the enhanced fastener and/or enhanced component can reduce the structural mass of the physical structure 110 in the enhanced model 120 while retaining the basic characteristics well within the target ranges established in the enhancement subsystem 200 by a user 102, or by the predefined default rules and embedded intelligence in the enhancement subsystem 200. In a preferred embodiment of the system 100, the optimization subsystem 4000 may include a conventional finite element optimizing tool that interfaces with the system 100 in a seamless and transparent manner. In alternative embodiments, the functionality of the optimization subsystem 4000 is built directly into the system 100.

D. Output Subsystem

The user 102 interacts with the system 100 through a user interface. In a preferred embodiment, the user interface is configured and designed to support ease of use, such as with a graphical user interface (“GUI”). New developments in user interface technologies can be incorporated into the system 100. The system 100 preferably provides certain common tools and screens that can be used throughout the process of modeling, evaluating, and enhancing characteristics of a model 120. In a preferred embodiment of the invention, the system 100 interfaces, preferably in a seamless manner, with a conventional finite element analyzer. In alternative embodiments of the invention, a finite element analyzer can be part of the system 100 itself, eliminating the need to interface with a conventional finite element analyzer.

A preferred embodiment may include a view tools screen to provide the user 102 the ability to view the model 120 from many different perspectives, without modifying the substance of the model 120. The view tools screen should behave in a manner consistent with the way such functionality is provided by a conventional finite element analyzer. A “special tools” window may provide the user 102 with whatever interface controls are specifically required to perform functionality specifically relating to the current particular stage of processing. Different buttons may appear in the special tools window depending on the type of processing currently underway. A utility tools screen can allow the user 102 to modify the substance of a design 34 or model; modify the display of a model 120 or design; and/or display special purpose objects that are not part of the model 120, including graphs of analysis, and other types of processing desired by the user 102. A main window can display specific information relating only to a single interesting location on the model 120, or broad aggregate information relating to the entire model 120. A menu box can be included to allow the user 102 to control the flow of analysis and predictions made by the system 100. If the system 100 utilizes the functionality of a finite element analyzer, a menu box can be used to activate the interface between the system 100 and the finite element analyzer.

In a preferred embodiment, particular shapes represent fasteners 128 in the system 100. Bolts are preferably represented by a rigid web connecting multiple parts 124 with at least one point not attached to any part 124 with each part having a hole filled by rigid web. Snaps are preferably represented by an elastic spring element. Rigid elements connecting parts 124 individually or a rigid chain connecting multiple parts 124 with every point attached to a part 124 can represent welds. In alternative embodiments of the system 100, fasteners 128 can be represented in any other forms of 1-, 2- and 3-dimensional rigid and elastic elements 126 as well as multi-point constraints. Bolts may also be represented using rigid elements. Other fasteners 142 can be represented by combinations of rigid and spring elements, or from other derivations of elements. In a preferred embodiment of the invention, welds can be identified as rigid chains with for example, the number of nodes being equal to the number of parts 124 attached. Bolts can be preferably identified as rigid chains with at least one node not attached to any part 124. Each weld chain can be remodeled with a separate force recoverable rigid element. Each bolt chain can be remodeled with rigid webs for each part 124 connected by separate force recoverable rigid elements along the non-part nodes.

III. Module-Level View

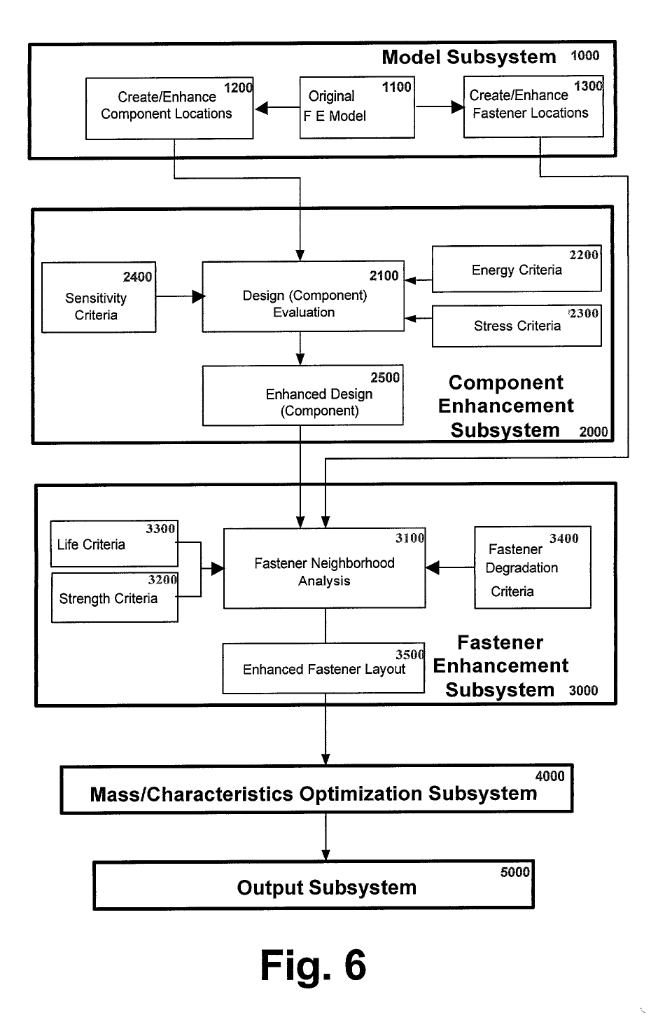

FIG. 6 discloses a more detailed example of a subsystem view, an illustration that includes some of the modules that can be utilized by the various subsystems. The system 100 can support a wide variety of different modules and combinations of modules. FIG. 6 is merely one example of a number of modules being used by the system 100.

A. Original Model

An original finite element module 1100 reads an existing finite element model from a conventional finite element analyzer, creates a new finite element model with a conventional finite element analyzer, or creates a finite element model using functionality within the system 100. All original model 185 information can then be saved to the database 108.

B. Create/Format Component Locations

A create/format component locations module (which can also be referred to as a create/format design module) 1200 is used for laying the groundwork (e.g. building tracking and evaluation mechanisms) with respect to component locations 183 in the initial model 186. Part connections can be created and/or cleaned (e.g. formatted or processed). Component locations 183, whether zones 134, joints 138, assemblies 122, or some other type of location, are created in the database 108 by modifying and/or reorganizing the original model 185 as desired. Elements 126 and/or nodes participating in the defined location are determined by using various heuristics, algorithms, calculations, processes, etc., some of which are described below. The various types of model locations 180 serve as mechanisms for tracking and evaluating design characteristics such as stress, energy, structural response parameters and other characteristics relating to component locations 183.

C. Create/Format Fastener Locations

A create/format fastener locations module 1300 is used for laying the groundwork (e.g. building tracking and evaluation mechanisms) with respect to fastener 128 locations in the model 120. Fastener 128 representations can be created and/or “cleaned” (e.g. processed). Node sets and/or element sets 144 can be created for the purpose of tracking various structural response parameters in the vicinity of the fasteners 128. The fastener location 184 is the mechanism for tracking force, stress, and other characteristics. Just as there can be a wide variety of different types of component locations 183, there can also be a wide variety of fastener locations 184, such as fastener nodes/node paris/element 144, fasteners 142 (including bolts, welds, springs, snaps, nails, screws, rivets, zippers, adhesives, or any other type of connector), and fastener areas 140.

D. Component Evalution

A component evaluation module (which could also be called a design evaluation module) 2100 is used to evaluate model locations with respect to various component (e.g. design) characteristics, such as energy content/distribution, stress distribution/concentration, sensitivity, and other characteristics. Locations 183 are preferably ranked with respect to one or more of the various component characteristics in an attempt to identify the critical locations 182.

E. Energy Criteria

An energy criteria module 2200 (“energy module”) creates structural eigen-value, static and dynamic response solution sequences (collectively eigen-value solutions) for a finite element analyzer. Energy distributions can be generated for each eigen-value as well as for each structural response frequency or load case of interest. Locations 183 can be sorted and ranked with respect to energy content, energy flow, and other characteristics.

F. Stress Criteria

A stress criteria module 2300 (“stress module”) creates structural eigen-value response solution sequences for a conventional finite element analyzer. Stress distributions can be generated for each eigen-value of interest as well as for each structural response frequency or load case of interest. Locations can be ranked and sorted with respect to stress and other related characteristics.

G. Sensitivity Criteria

A sensitivity criteria module 2400 (“sensitivity module”) can create a structural sensitivity analysis sequence for a conventional finite element analyzer. Sensitivity indices can be generated across all location types, for particular location types, or for a partial combination of all location types for any type of load case of interest. Sensitivity indexes are preferably generated with a conventional finite element analyzer, although in some embodiments of the system 100, the optimization process could be performed internally.

H. Enhanced Component

An enhanced component module (which can also be referred to as an enhanced design module) 2500 is preferably used to identify interesting 181 and/or critical locations 182 with respect to model sensitivity, to energy distribution, stress, distribution and other component characteristics. The locations with high design sensitivity can be enhanced for greater rigidity/stiffness, while the locations with low design sensitivity can take reduced rigidity/stiffness. On the other hand, the less sensitive locations may be offered less changes in their design unless they can reduce the structural mass effectively. The enhance design module 2500 is responsible to determine whether a particular enhanced model 120 satisfies the target constraint. The target constraint can be set by the user 102, or it can be set by the system 100 itself in the form of predefined rules, overrideable defaults, historical categories of design/engineering issues, and other characteristics.

I. Fastener Area Analysis

A fastener neighborhood analysis module (which can also be referred to as a fastener neighborhood analysis module) 3100 is preferably used to evaluate strength, life (e.g. lifespan or durability), and other characteristics in the vicinity (e.g. fastener area 140) of each fastener, a continuum “neighborhood” of the fastener. Fastener areas 140 and other fastener locations 184 can be ranked with respect to strength, lifespan, and other fastener characteristics. The preferred fastener neighborhood analysis module includes a strength criteria module 3200, a life (durability) criteria module 3300, and a fastener degradation criteria module 3400. The fastener neighborhood analysis module serves an optimal fastener layout module 3500 that computes an enhanced fastener component for the structure 110. The various potential modules of the fastener enhancement subsystem 3000 are described below.

J. Strength Criteria

A strength criteria module 3200 (“strength module”) is used to create structural eigen-value/static/dynamic forces for fasteners 142, generating a strength index ranking for each fastener location. The strength indices should preferably rank the fasteners 142 with respect to their relative load sharing in each eigen-value or using the static/dynamic response solution, the system 100 can generate the fasteners 142 with respect to relative force, stress, and other characteristics, as subject to the practical static/dynamic loads.

K. Life Criteria Module

A life criteria module 3300 (“life module,” “life evaluation module,” or “life-span module”) is used to evaluate the projected lifespan (e.g. durability) of the various fastener locations 184 in the model 120. The module 3300 can creates a structural response solution sequence for a finite element analyzer subject to the practical dynamic loads. From the response solution, stress cycles at the various fastener locations 184 are generated, along with neighborhood (e.g. vicinity or fastener areas 140) structural continuum elements. An estimate for the relative life of the fastener location 184 is generated, considering both fastener failure as well as neighborhood structural failure. Fastener locations 184 can be ranked and sorted with respect to lifespan and related characteristics.

L. Degredation Criteria

A degradation criteria module 3400 (“degradation module”) can evaluate the influence of the absence of interesting and/or critical fastener locations with respect to strength and/or lifespan, and the influence of failures with respect to the failures and durability of the assemblies 122. This module 3400 confirms which fastener locations are in fact the most critical for purposes of enhancement with respect to a particular characteristic.

M. Optimal Fastener Layout

An optimal fastener layout module 3500 (“layout optimization module”) provides the ability to re-space fastener locations based on desired enhancements to the model 186. Characteristics such as strength, lifespan, and other characteristics, either individually or in combination with each other (e.g. weighted averages) can be used to determine better fastener strength distribution and load flow within a potential physical structure 110. The dynamic characteristics of the various models 120 can be compared with other models 120 to further delineate different design tradeoffs and decisions. Various iterations of enhancement can be invoked by this module 3500.

IV. Overall Process Flow

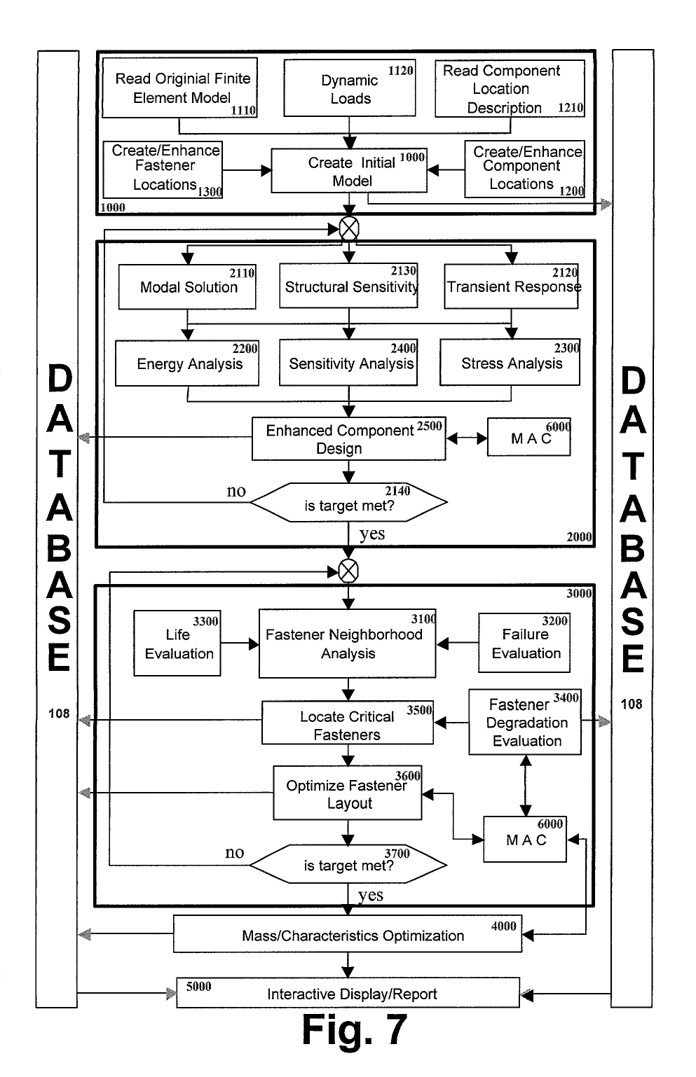

The various subsystems and modules that can be incorporated into the system 100 in many different ways, each way resulting in a different example of an overall process flow. For example, in some embodiments the component enhancement subsystem (which can also be called a part design enhancement subsystem) 2000 is invoked before the fastener enhancement subsystem 3000, while in other embodiments, the fastener enhancement subsystem 3000 is invoked before the component enhancement subsystem 2000. Similarly, the order, type, and number of modules utilized by the various subsystems can also vary significantly. The process flow in FIG. 7 is one example of process flow for the system 100. Each process in the flowchart can be referred to and identified as a module. The first group of modules relate to processing by the model subsystem 1000.

A. Model Subsystem

1. Original Finite Element Model Module

A read original finite element models module (“unprocessed finite element model module”) 1110 is used to read, create, and/or receive a finite element model 185. In some embodiments, a finite element model created with a conventional finite element analyzer is imported into the system 100. In other embodiments, the system 100 is used to create a model (either a processed model 186 or an unprocessed model 185) internally, and that model can then be read into the model subsystem 1000.

2. Dynamic Loads Module

A dynamic loads module 1120 can then be used to read dynamic loads in any format, time-history, magnitude-phase, real-imaginary, power spectral density, or any other useful format. This module 1120 can transform the load information into a form that is suitable for the structural evaluation process and the framework of the system 100 that is either selected by the user 102, or set by a predetermined system rule or default. In a preferred embodiment, all inputs are converted in to a magnitude-phase format and used. The dynamic load module 1120 can locate the load application points and the load application degrees of freedom, preferably using a graphical user interface (“GUI”) and build the load information into the model 120 for future processing by the system 100.

3. Read Component Locations Descriptions Module

A read component locations descriptions module (which can also be called a read design locations descriptions module) 1210 can be used by the system 100 to identify the types of model locations that will be processed by the system 100. Model locations 180 form the basic structure that is processed by the system 100. As described above, the system 100 selectively identifies a subset of interesting locations 181 from all of the locations and/or potential locations 180 in a model 120. A subset of interesting locations 181 are ultimately identified as critical locations 182. The system 100 can support a wide variety of different structural units that can collectively be referred to as locations in the model 120. One type of model location is a part 124. In a preferred embodiment, component locations 183 include parts 124. Other component location type 183 include zones 134, joints 138 and assemblies 122. Other component location types 183 may be created, and the system 100 anticipates the creation of location types 180 to support system 100 flexibility and effectiveness. The same physical structure can be analyzed in multiple ways by analyzing the design with different models 120 using different location types. One model 120 can include more than one type of location. This module relates to component locations 183 (e.g. design locations 183), as opposed to fastener locations 184, and thus the locations can be referred to as non-fastener locations 183, design locations 183, or component locations 183. Zones 134 can be referred to as design zones 134 (or component zones 134), the joints 138 can be referred to as design joints 138 (or component joints 138), and the assemblies 122 can be referred to as design assemblies 122 (or component assemblies 122)..

Predefined default rules may determine which type of location or locations are read into the system 100. In a preferred embodiment, users 102 can override any such defaults. However, it is also preferred that predefined rules provide users 102 with guidance with respect to which approaches are more effective with respect to different contexts. Design location descriptions can be imported from a file, or can be inputted by a user 102 through a graphical user interface (or some other form of user interface). If locations are determined by binding volume, the location can be called a joint 136. If locations are determined by a set of elements, the location can be called a zone 134. If locations are determined by a set of parts, the location can be called an assembly 122. As mentioned above, the system 100 can support a wide variety of different location types, and a wide variety of different combinations of location type in the same model 120.

4. Create/Format Component Locations Module [0097] A create/format component location module (which can also be referred to as a create/format design locations module) 1200 can be used to read, create, identify, and properly format the various locations 180 in a model 120. In a preferred embodiment, zones 134 are used, but other types of locations and combinations of locations can be used by the system 100. The creation of model locations is a prerequisite for later determining which model locations are “interesting” with respect to one or more characteristics, and which model locations are “critical” with respect to one or more characteristics. The creation and/or enhancement of zones (or other component locations) can be facilitated by the creation of the assembly 122, zone 134, and joint 138 information on the database 108. This can require the modification, formatting, and/or reorganizing of the original model 185. Elements 126 and/or nodes participating in the defined zone 134 can be found and collected by implementing various processing steps, which are discussed below. New parts 124 that represent the equivalent of old parts 124 may be required to replace the old parts. All information should be saved to the database 108, including information relating to part/element/node relationships and enhanced model locations.

5. Create/Format Fastener Locations Module

A create/format fastener locations module 1300 is used to create the various model locations used by the system 100, regardless of the particular location type(s). It is the model locations that provide the mechanism for various characteristics to be tracked, evaluated, enhanced, and optimized. The module 1300 can identify all rigid and spring elements, and chain those elements, “cleaning” any interdependencies and spurious dependencies. Rigid and/or spring elements can be remodeled with an appropriate local coordinate system(s) for tracking stresses, forces, and other fastener characteristics. Fasteners 142, fastener areas 140, and/or other fastener locations 184 can be sorted, and saved into a fastener database 108. The processed fastener locations should be created as contiguous parts. All relationships, locations, and coordinate systems should be saved to the database 108.

6. Create Model Module

A create model module 1002 takes the processing of all the other modules in the model subsystem 1000 and creates an initial model 186, a model 120 ready to be enhanced by the enhancement subsystem 200. The initial model 186 created by the create model module 1002 is different than the unprocessed model 185 originally inputted into the system 100, the enhanced model 188 that is created by the enhancement subsystem 200 or the optimized model created by the optimization subsystem 4000. Degraded models 191 and upgraded models 194 can also be created.

B. Component Enhancement Subsystem

1. Modal Solution Module

A modal solution module 2110 creates a request for an eigen-value solution and/or solution sequence (collectively eigen-value response). In a preferred embodiment, the solution request is sent to a conventional finite element analyzer, with the answer being sent back the modal solution module 2110. All such communications should be transparent to the user 102. In alternative embodiments, the modal solution module 2210 can itself create the eigen-value solution or solution sequence internally. Regardless of the source of the solutions, the module 2110 extracts mode shapes, stresses, energies, forces, and other characteristics that can be subsequently enhanced by the system 100.

2. Structural Sensitivity Module

A structural sensitivity module 2130 evaluates the model 120 with respect to identifying structurally sensitive locations in the model 120. The module 2130 creates a solution request for structural sensitivity analysis that can either be performed within the system 100 or by a conventional finite element optimizer or analyzer interfacing with the system 100. Regardless of the source of the results, the structural sensitivity module returns sensitivity indices for some or preferably all of the parts 124 in the model 120.

3. Transient Response Module

A transient response module 2120 creates a solution request relating to the dynamic response characteristics such as displacements, stresses, energies, forces, and other characteristics of the physical structure 110 represented by the model 120 for subjected to dynamic loads. The solution request by the module 2120 is preferably sent to a conventional finite element analyzer, where it is solved, and transparently sent back to the transient response module 2120. In alternative embodiments, finite element analyzer functionality is incorporated directly into the transient response module 2120.

4. Energy Analysis Module

An energy analysis module 2200 is used to evaluate component (e.g. part design) characteristics of the model 120 with respect to energy distribution. A finite element solution for the energy distribution can either be inputted into to the system 100, or generated within the system 100. The energy analysis module 2200 can then compute the energy contained in one or more parts 124, the effective energy density of one or more parts 124, and the relative energy content for one or more parts 124. Similar energy results can be calculated at the zone 134, joint 138, and assembly 122 level, as well as at any other type of location 180 for which such calculations can be performed consistent with the laws of physics. The results of the energy analysis can be sorted with respect to each type of location. Critical locations 182 of all types can be selectively identified, in a number consistent with the desires of the user 102 and/or system defaults and predefined targets. The energy, energy density, and relative energy content are each distinct energy characteristics, and should be treated distinctly by the system 100 in a preferred embodiment.

5. Sensitivity Analysis Module

A sensitivity analysis module 2400 (or simply “sensitivity module”) uses the finite element solution relating to structural sensitivity as its inputs. Structural performance in the form of modal, force, and other responses are evaluated in the context of part 124 characteristics such as thickness. Sensitivity characteristics are preferably calculated for each part 124, zone 134, joint 138, assembly 122, and any and all other location types processed by the system 100. All location types can be sorted based on a sensitivity index, which can be configured to create distinct indexes for each location types. In alternative embodiments, there can be multiple location types in a single sensitivity index. Critical locations 182 from a sensitivity characteristic perspective can be identified on a sensitivity characteristic by sensitivity characteristic basis.

6. Stress Analysis Module

A stress analysis module 2300 (or simply the “stress module” 2300) uses finite element solutions relating to stress distribution, force distribution, and other types of characteristics as inputs to the module 2300. The stress module 2300 can then calculate the effective stresses at each of the fasteners 128 and fastener neighborhood (e.g. fastener area 140). Stress characteristics can be sorted for all location types, such as parts 124, zones 134, joints 138, assemblies 122, and any other location type processed by the system 100. For the purposes or ranking and sorting in a preferred embodiment, each location type 180 is distinct, and treated distinctly from other location types. In alternative embodiments, a single stress index can include locations of more than one location type.

7. Enhanced Component Module

An enhanced component module (which can also be called an enhanced part design module) 2500 uses as inputs, the results of the other modules within the component subsystem 2000. The component module 2500 can modify part parameters (e.g. characteristics) such as thickness and other characteristics or suggest reinforcements, to bring in the maximum effect of smoothening the energy flow and reducing stress concentrations in the model 120. The various evaluation and analysis modules can be repeated on the enhanced model 188 created by the enhanced component module 2500. Results relating to energy flow and stress distribution can be compared between the various enhanced models 188 and the initial model 186 using a modal assurance criteria module 6000. All data and all iterations of data, should preferably be stored on the database 108 for various purposes, including model comparison.

8. Modal Assurance Criteria Module

The modal assurance criteria module 6000 is the means by which the system 100 can compare different models 120. Comparisons can be invoked using any of the displacement or mode shape characteristics tracked by the system 100. Comparisons can also involved multiple types of characteristics and multiple types of model locations. Weighted averages can be taken to generate overall scores on which to rate and rank various iterations of enhanced models 188 from a common initial model 186. The weighting schemes used by the system 100 can be based on predefined default values (which can be overridden) and embedded intelligence taking into account as many characteristics and classifications relevant to the model 120. Weighting schemes can also be made by a user 102 through the use of a user interface.

9. Target Constraints Module

The enhancement process is an iterative process. Evaluations and enhancements can be made multiple times until the results are found to be successful. A target constraints module 2140 determines whether target constraints are satisfied by a particular enhanced model 188. Target constraints can related to as few as one characteristic, or as many as all characteristics. Target constraints can be weighted to provide for certain tradeoffs, or each target constraint can exist on a distinct basis for each distinct characteristic. Until successful results are obtained, the iterative process of the component (e.g. part design) enhancement subsystem 2000 should continued. With successful results, the process can then move forward to the fastener enhancement subsystem 3000.

C. Fastener Enhancement Subsystem

1. Life Evaluation Module

A life evaluation module 3300 (“life analysis,” “lifespan analysis,” or “duration analysis”). This module identifies which location(s) are likely to first fail as the result of durability limitations/use. Finite element solutions for fastener forces such as constraint forces in fastener elements and stresses in the neighborhood plate elements are input into the life evaluation module 3300. Fatigue data can be computed from the fastener force and neighborhood stress cycles from the solution. Critical structural life computations should be performed for each type of fastener location 184. Fastener locations can then be sorted and ranked with respect to model locations using durability as the characteristic for identifying critical locations in the model.

2. Failure Evaluation Module

A failure evaluation module 3200 (“strength evaluation module” or “strength module” 3200) is used to identify the locations 184 on the model 120 that are likely fail not as a mater of fatigue or use, but as a matter of stresses and other loads that are not primarily time-based. The strength module 3200 uses an inputs, finite element solutions for constrain forces in fastener elements and stresses in the neighborhood plate elements. Critical stresses should be calculated for each fastener location based on user-provided fastener dimensions, or using predefined rules and embedded intelligence utilizing historical data and other characteristics and engineering/design categories. Fastener locations can be sorted and ranked based on critical stress. Such indices can treat each distinct location type distinctly, or a single index can include more than one location type.

3. Neighborhood (Fastener Area) Analysis Module

A neighborhood analysis module (which can also be called a Fastener Area Analysis Module) 3100 can integrate the strength/failure and lifespan/durability characteristics discussed above, in addition to other characteristics tracked by the fastener enhancement subsystem 3000.

4. Degradation Evaluation Module

A degradation evaluation module 3400 (“degradation module” 3400) eliminates critical fasteners 182 from the model 120 by eliminating the corresponding fastener elements 144 from the model 120. Eigen-values can then be generated, either internally, or from a conventional finite element analyzer. Dynamic characteristics of the degraded model 191 can be compared with the enhanced model 188 by the modal assurance criteria module 6000. Fastener failure should be evaluated and compared with the critical fastener life of the enhanced model. Structural degradation due to the absence of critical fasteners can be assessed from several different points of view, including structural stiffness (e.g. frequencies), strength/failure, lifespan/durability, and other characteristics. If the degradations to the overall degraded model 191 are significant, than the identified critical fasteners truly are critical. Thus, this module 3400 facilitates the determination of how critical the critical fasteners really are.

5. Locate Critical Fasteners

A locate critical fasteners module 3500 (“critical fasteners module” 3500) sort through some or preferably all fasteners/fastener locations from a strength/failure point of view, and identify critical fasteners and their neighborhoods with respect to the strength/failure characteristic. A parallel process can be undertaken with respect to other fastener characteristics, such a life/durability. The critical fasteners module 3500 can also combine fastener characteristics in a weighted fashion to generate weighted critical fasteners. A degradation analysis from the degradation module 3400 should be used to confirm the “critical” status of any fasteners within the model 120.

6. Layout Optimization Module

A layout optimization module 3600 (“fastener optimization module” or “optimization module” 3600) facilitates improvements to the fastener layout by re-spacing the fasteners 142 so that the most critical locations 182 are reinforced while removing fasteners 142 from the least critical locations. Re-spacing can be performed in accordance with user-specific constraints (through a user-interface), or can be performed automatically by the system 100 using predefined rules and embedded intelligence utilizing historical information, structure-type classifications, and any other potentially relevant information. Eigen-value solutions can be generated for the various enhanced models 188 of the system 100. The modal assurance criteria module 6000 is preferably used to compare the various enhanced 188 and initial models 186. Comparisons can be made with respect to dynamic characteristics, fastener failure critical fastener strength, fastener lifespan and critical fastener lifespan, and other characteristics. The structural performance is preferably assessed with respect to many different points view (looking at a wide variety of different characteristics) such as structural stiffness (frequencies), strength/failure, and life/durability. This should be used to enhance structural efficiency.

7. Modal Assurance Criteria Module

As discussed above, the MAC 6000 facilitates comparison of data to confirm identification of critical locations, evaluate the degree of “criticalness” with respect to characteristics, and the various tradeoffs involved with different enhanced model iterations. Frequent comparisons is preferable if many enhanced iterations are being generated by the system 100.

8. Target Constraints Module

As discussed above, a target constraints module 3700 is also preferably incorporated into the fastener enhancement subsystem 3000. As discussed above, there are a wide variety of different ways in which to set target constraints, and such constraints can incorporate many different weighting schemes and characteristics. A target constraints module 3700 for the fastener enhancement subsystem 3000 is similar to the constraints module 2140 for the design enhancement subsystem 2000, except that fastener characteristics are used in generating the constraints instead of part design characteristics.

D. Mass/Characteristics Optimization Subsystem

A conventional finite element optimizer can fulfill the role of an optimization subsystem 4000, or the system 100 can provide this functionality internally. This subsystem 4000 is used to carry out a “full fledged” structural optimization of the enhanced model 120 to further optimize the structural parameters (e.g. characteristics) such as mass, retaining the target constraints using the enhanced objective function generated by the system 100 or user specified objective function for the enhanced model generated from the part design enhancement subsystem 2000. Comparisons can be performed with the structural stiffness, strength, lifespan, structural mass, and other characteristics in the optimized model with reference to the initial model(s) 186, the enhanced model(s) 188 generated by the component enhancement subsystem 2000 (the component enhanced model 189), the enhanced model(s) generated by the fastener enhancement subsystem 3000 (the fastener enhanced model 190), and the optimized model(s) generated by the optimization subsystem 4000. This subsystem 4000 can be used to assess the degree of improvement in structural efficiency resulting for the overall processing of the system 100.

E. Interactive display/Report

The output subsystem 5000 can provide a wide variety of different interactive displays and reports. Interaction for extracting user choices using a user-interface can change the default values applied by the system 100. Such choices are preferably relevant with respect to both presentation and analysis. This subsystem 5000 can also provide for interactive: model manipulations, display/presentation of results, display of fastener and design locations, display of loads and their application locations, and the display of general finite element solutions that are generated by conventional finite element analyzers. Interactive display/report processing has a wide variety of automated reporting functions, such as: executive summaries of enhancements; fastener layouts for unprocessed original model 185, the initial model 186, the component enhanced model 189, the fastener enhanced model 190, the optimized model, and other models 120; salient results for the various models 120; salient comparisons of various models 120; and a wide variety of HTML/text reports. The reporting and display functions utilize predefined rules and embedded intelligence, utilizing historical, structure-type, and other characteristics in determining what information is likely to be of interest to users 102.

F. Database Processing

The database 108 incorporated into the system 100 preferably stores all model data in a comprehensive and efficient manner so that processing can be interrupted and resumed without a net loss of time. The database 108 can store model data, finite element solutions e.g. characteristics (eigen values, responses, sensitivities, and other characteristics described above and below), location evaluation results, model degradations/restorations (e.g. upgrades), etc. for instant availability. The database 108 should be configured to maximize the various display and reporting functions of the system 100. Different technical platforms may present unique challenges and unique opportunities for database functions. Major database interactions in a preferred embodiment include: updating model data; saving the enhanced model 188 and its results (modal, response, sensitivity, etc.); saving the degraded fastener information along with its results (modal, response, sensitivity, etc.); saving critical fastener data; saving optimal layout information and the associated results (modal, response, sensitivity, etc.); and saving the optimized model, with all of its relevant and helpful characteristics. Different embodiments of the system 100 utilize different data types, but the database 108 should be configured in each of those different embodiments to maximize the storage and utilization of past data.

V. Detailed Process Flow

Just as each of the subsystems in the system 100 can incorporate a wide variety of different modules, the modules and processes of FIG. 7 can each incorporate a wide variety of functions, process steps, and other components in their processing. Each module or process step in FIG. 7 is capable of being described in even more detailed flow charts and process diagrams. Each of these more detailed process flows are provided as illustrative only, because there are a voluminous number of different iterations that can be incorporated into the system 100.

A. Model Input/Output Operations

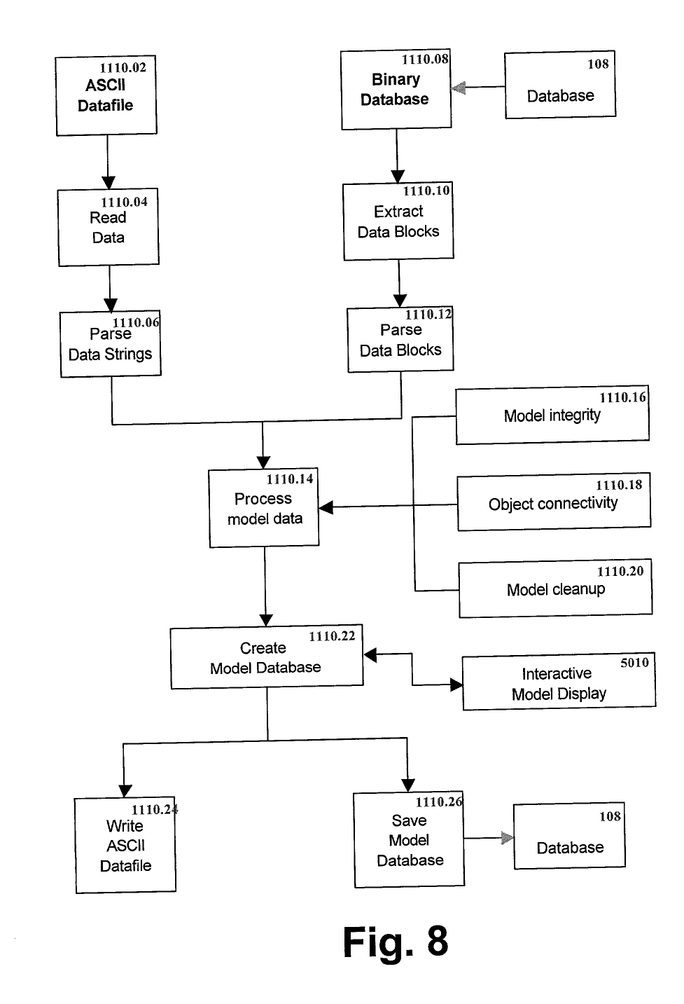

FIG. 8 is a flow chart illustrating one example of a model input/output process. The model input/output process of the finite element module 1110 can begin with a ASCII datafile at 1110.02. This datafile contains the raw unprocessed finite element information necessary for generating a processed initial model 120 capable of being processed by the system 100.

At 1110.04 the data file is read into the system 100. Data strings are parsed at 1110.06 in a prescribed format that can vary widely from embodiment to embodiment.

One alternative to an ASCII file input file is data that is stored in a binary database at 1110.08. Data blocks can be extracted at 1110.10 in a prescribed format, which can vary widely from embodiment to embodiment. The extracted data can be parsed into data blocks at 110.12 that resemble in certain ways, the parsed data strings at 1110.06.

At 1110.14 the data is processed from an unprocessed model 120 into an initial model 120. This process is supported by a check on model integrity at 1110.16, an establishment of connectivity among different finite element objects in the model at 1110.18, and a model cleanup process at 1110.20. The model cleanup process at 1110.20 should include removing data or modeling errors, and any other anomalies, including the resolution of any interdependencies.

At 1110.22 the initial model is created. The initial model should be viewable by the interactive model display at 5010 at any time such a view is desired by the user 102. An ASCII file is written at 1110.24 to support the ability of the system 100 to export solution response sequences of the initial model to conventional finite element analyzers. The model should also be saved on a model database at 1110.26 to facilitate repeated retrievals.

B. Creating Models

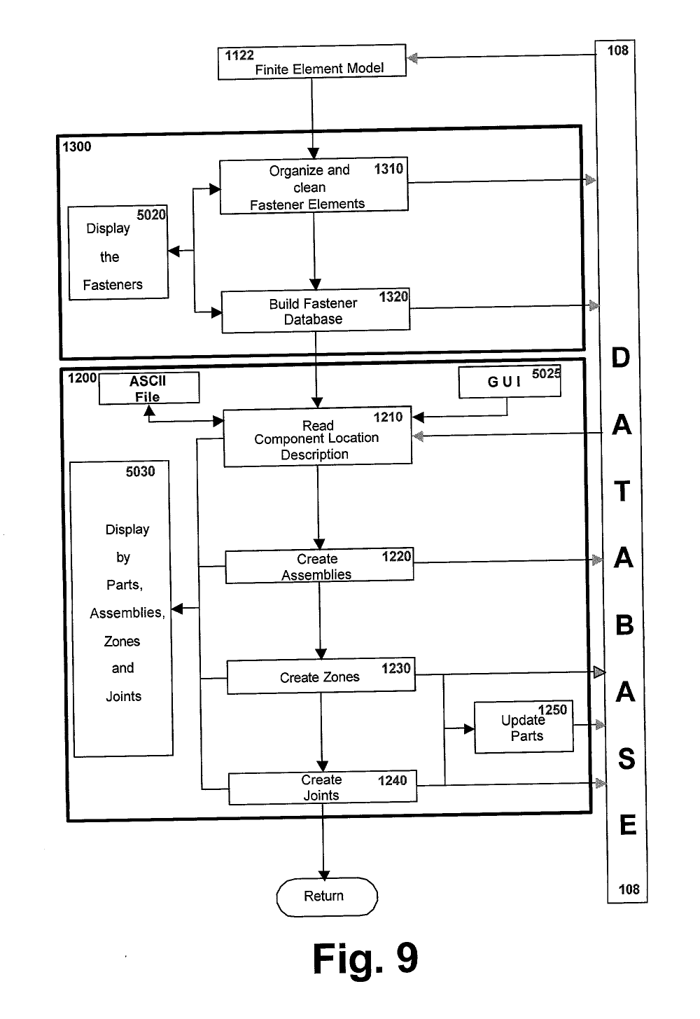

FIG. 9 is a flow chart illustrating one example of a create model process continues the process that begins at 1110.22 in FIG. 8. The flow chart in FIG. 9 discloses a process for creating a subset of interesting locations 181 in the initial model 186. At 1122, an initial model 186 is retrieved from the database 108. In an alternative embodiment, the information is retrieved from as ASCII file or any other format capable of embodying finite element information.

At 1310, fastener elements are organized and cleaned. Fastener elements are identified as rigid elements, spring elements, other potentially other element categories. Fastener elements can then be chained. Fastener chains should be examined for their correctness, and cleaned if required. All data as modified should be saved in a binary form for repeated retrievals to facilitate the ability to provide repeated displays at 5020.

A fastener database is built at 1320. Fasteners 142 and other types of fastener locations 184 are identified and isolated from the associated bunch of elements. Fastener elements are replaced with force recoverable elements and mechanisms (i.e. fastener locations) are built to track results such as displacements, forces, and other characteristics at the associated nodes. The part mesh is preferably modified locally to accommodate the best mesh around each fastener 142 so that it is normal to the fastener surfaces. All generated information and data should be saved in a database 108 in a binary form for repeated retrievals.

Component (e.g. part design) location 183 descriptions are read into the system 100 at 1210. This process can be implemented by importing data from an ASCII file or by a user entering the data in the form of a user interface such as a GUI at 5025. Descriptions for all location types to be processed by the system 100 (preferably including zones 134, joints 138, and assemblies 122) need to be inputted at 1210. The data can also be imported from the database 108 from previous “saves.”

Assemblies can be created at 1220. Parts 124 are identified for each assembly and the assembly database is built, including assembly-part connectivity. The generated information can be saved in the database 108, preferably in a binary form for repeated retrievals.

Zones can be created at 1230. Elements 130 and the parts 124 for each zone 134 are identified. If a part 124 has a partial set of its elements 126 participating in the zone 134, the part 124 is split into two parts 124 with all of the participating elements 126 in one part 124 and the non-participating elements 126 in the initial part description. The part database 108 is updated with respect to the new parts. The zone database can then be built with all participating parts 124. All zone information should be saved in the database 108 in a binary format to facilitate repeated retrievals.

Joints can be created at 1240. The element set 126 belonging to the joint 138 is identified by volume boundaries 132. All associated parts 124 should also be identified. If a part 124 has a partial set of its elements participating in the joint 138, the part 124 should be split into two parts 124 as described above. The part database 108 should also be updated as described above. The joint database should be built using all of the participating parts 124. All generated data should be saved in the database, preferably in a binary format for repeated retrievals.

The parts database should be updated at 1250. The assembly 122 for each part 124 is initialized. Whenever a part is split as described above, the old part definition (the pre-divided part) should be deleted completely. All of the generated information should be saved in a database 108, preferably in a binary format for repeated retrievals.

At 5030 (which can be anytime in the processing of the system 100), the user 102 can display the model 120 by parts 124, unprocessed parts 124, assemblies 122, zones 134, joints 138, and elements 126.

C. Organizing Fastener Elements

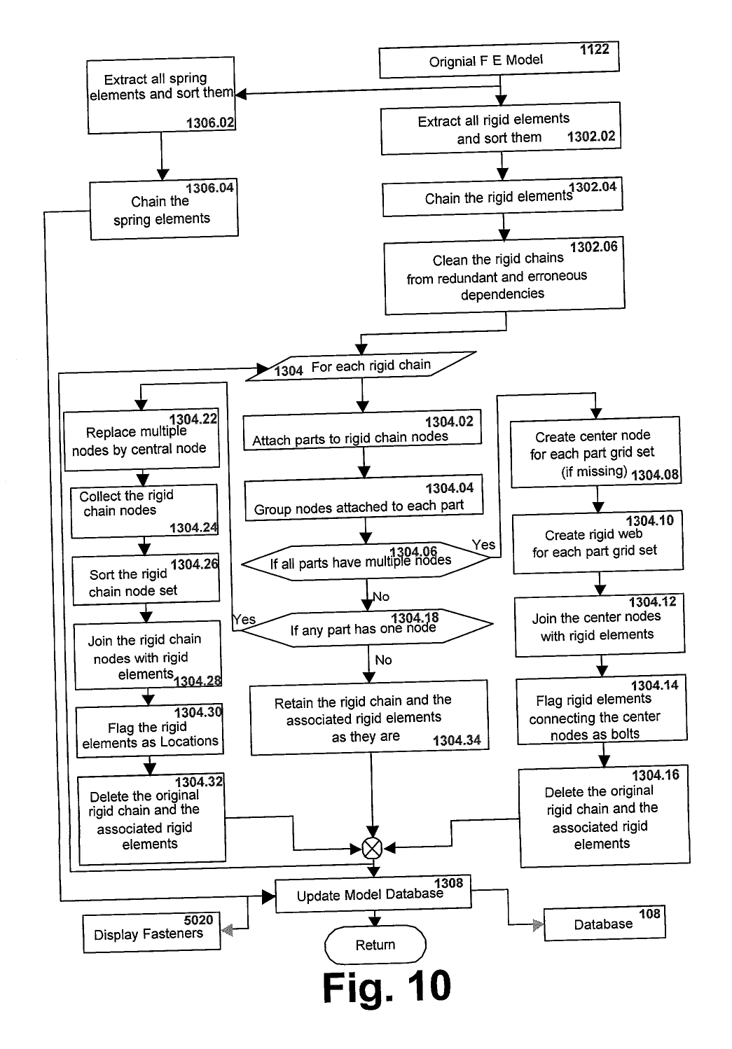

FIG. 10 is a flow chart illustrating one example of a process for organizing fastener elements. At 1122 is the retrieval of the initial finite element model, a processed and cleaned model ready for processing by the system 100. The process then forks into two threads.

The first threat begins at 1306.02 all elements in the model 186 are searched, identifying them and pooling together spring elements connected to each other (e.g. have a common node). Clusters are created of spring elements attached to each other at 1306.04. Spring elements can then be chained.

The second threat begins at 1302.02 with the search of all elements in the model for rigid elements so that they can be pulled. The rigid elements can then be chained at 1302.04. Each group of rigid elements that are connected should be collected. The dependency structure of the bunched rigid elements is preferably analyzed. Elements 126 can then be re-chained as a single independent node. At 1302.06 the dependency of all dependent nodes can be checked with reference to the independent node and remove all redundant and erroneous dependency relations.

At 1304 begins a loop for processing each rigid chain to identify rigid elements representing a fastener. At 1304.02, parts are attached to rigid chain nodes. At 1304.04 group nodes are attached to each part 124. If all parts 124 have multiple nodes at 1304.06, the process moves to 1304.08 to create center node for each part grid set. If any part has only one node at 1304.18 the process moves to 1304.22 to replace multiples nodes by a central node. If no part has only one node at 1304.18, the rigid chain and associated rigid elements are retained at 1304.34.

The thread at 1304.08 continues at 1304.10 where a rigid web can be created for each part grid set. Parts 124 can be attached to rigid chain nodes. The parts 124 attached to each node of the rigid chain can be found and identified. Nodes not attached to a part 124 can be marked by the system 100. At 1304.12 the center nodes are joined with rigid elements, a convention finite element representation. The number of distinct parts attached to the chain are identified by the system 100. All the nodes attached to a particular part are grouped together. The system 100 then determines the number of nodes associated with each part 124. At 1304.14, rigid elements are flagged. The multiplicity of the numbers associated with each part 124 is checked. If the number of nodes per part is greater than 2, the chain represents a bolt and the process of building a bold model described below is invoked. If the number of nodes per part is less than or equal to 2, the chain does not represent a bolt. The original rigid chain and associated rigid elements are deleted at 1304.16.

The second thread beginning at 1304.22 with the replacement of multiple nodes by a central node. At 1304.24, the rigid chain nodes are collected. At 1304.26, the rigid chain node sets are sorted. Rigid chain nodes are joined with rigid elements at 1304.28. At 1304.30, the rigid elements are flagged as welds. The original rigid chain and associated rigid elements are deleted at 1304.

At 1308, the model database should be updated. All updates should be displayable to the user 102 at 5020.

D. Building Fastener Database

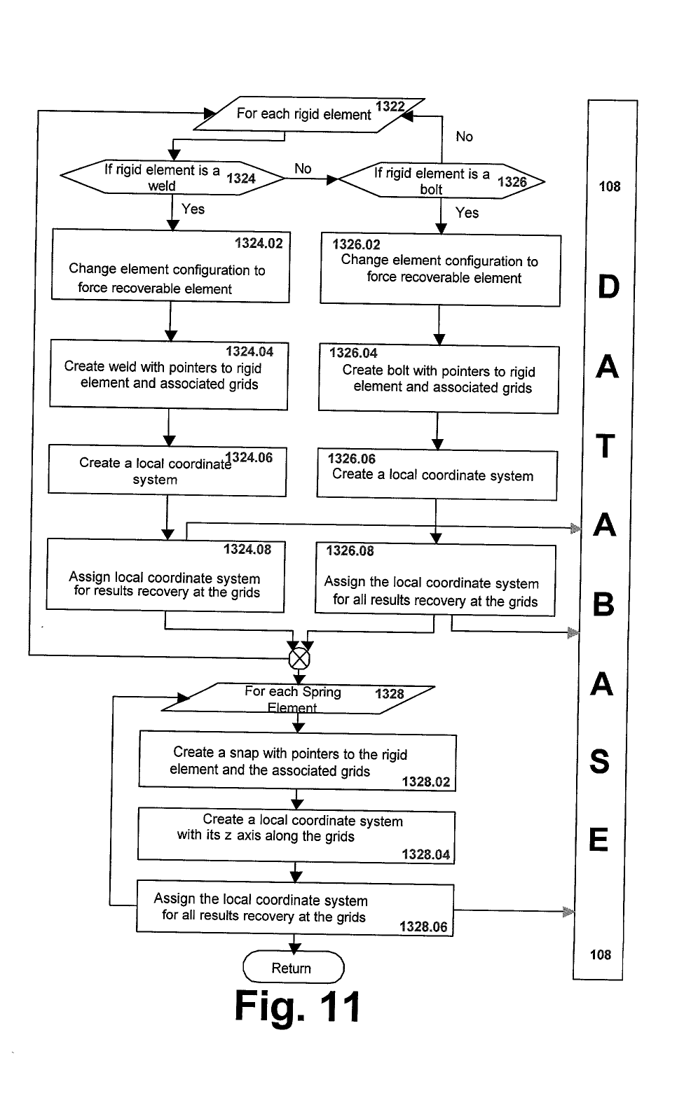

FIG. 11 is a flowchart illustrating one example of how the system 100 can build a fastener database 108. At 1322 is a loop for processing each rigid element to build the database 108 of rigid fasteners. If the rigid element is a weld, the loop at 1324 is performed. If the rigid element is a bolt, the loop at 1326 is performed. For each spring element, the loop at 1328 is performed.

1. Welds

At 1324.02, the element configuration is changed to force recoverable elements. At 1304.04, a weld is created with a pointer to the rigid element and the associated grids. At 1304.06, the average grid normal is found for the element 126. At 1304.08, new Cartesian coordinate systems are assigned as the results recovery system to the weld nodes. All changes and data (including the coordinate system data and associated grid data) are saved to the database 108

2. Bolts

Bolts are processed at 1326. At 1326.02, element configurations to force recoverable elements are changed. At 1326.04, a bolt with a pointer to the rigid element and the associated grids is created. A local coordinate system is created at 1326.06. The normal vector at each node is computed as the mean of the normal vectors at the nodes attaching the corresponding node to the respective part 124. The average grid normal is found as the average of the two normal vectors computed at the two nodes. The Cartesian coordinate system with the z-axis along the average normal grid. At 1326.08, a new Cartesian coordinate system can be assigned as the results recovery system to the bold nodes. All data is preferably saved to the database 108, including bold data with the associated coordinate system and other data of the associated grids.

3. Snaps

Spring elements are processed at 1328. At 1328.02 the system 100 creates a snap with a pointer to the spring element and the associated grids. At 1328.04, the system 100 finds the average grid normal for the spring element. A Cartesian coordinate system is the created with the z-axis along the average grid normal. Collect all the spring elements attached to the current spring element to make a cluster. Assign the common system to all the nodes in the cluster. If more than one spring element is present in the cluster, the degree of freedom direction for each spring is identified and stored. The results are interpreted in the appropriate degrees of freedom while processing the results. All the elements in the cluster are flagged for eliminating duplicate considerations. At 1328.06 new Cartesian coordinate system are assigned as the results recovery system to the snap nodes. All data and the associated coordinate system (including the updated associated grid data) is then saved to the database 108.

E. Creating Design Locations

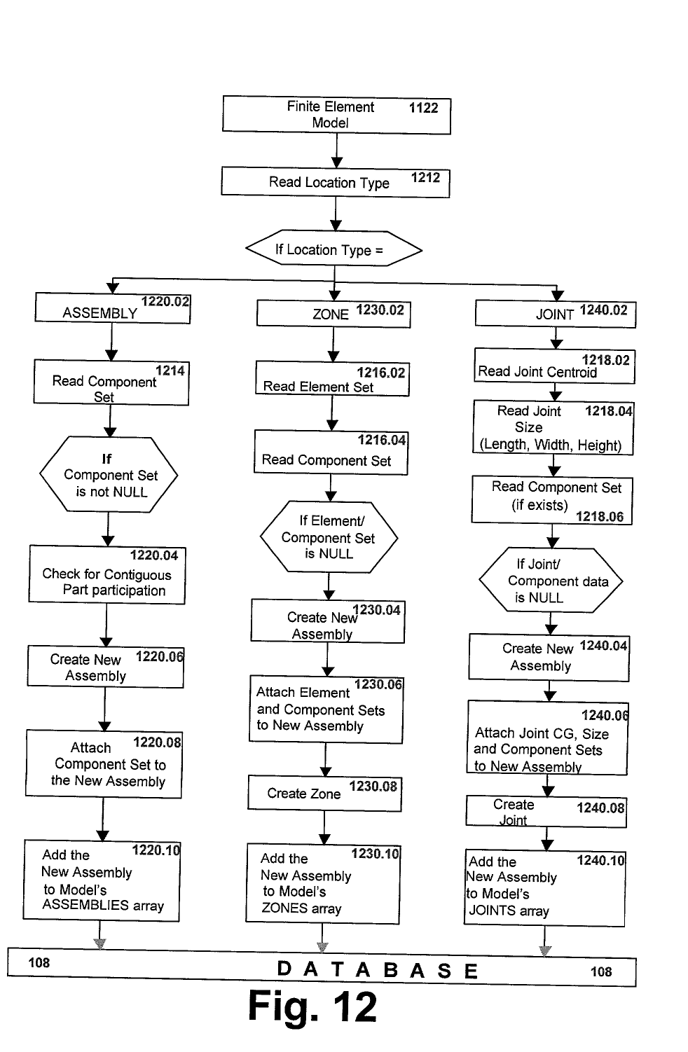

FIG. 12 is a detailed flowchart illustrating one example of how the system 100 can create design locations such as joints 138, zones 134, and assemblies 122. At 1122 the initial model 186 is read-in as an ASCII file or binary database with fasteners processed or unprocessed. At 1212, the location type is read from the ASCII file, from the binary database, or from the GUI or other user interface. Assemblies are processed at the loop beginning at 1220.02. Zones are processed at the loop beginning at 1230.02. Joints are processed at the loop beginning at 1240.02.

1. Assemblies

The assembly component set is read at 1214. As discussed above, this can be accomplished using an ASCII file, a binary database, a GUI, or some other means. If the component set is not null, the process proceeds to 1220.04, with the checking for contiguous part participation. Contiguous parts 124 that are split between two assemblies 122 should be identified as a special case. A new assembly can then be created at 1220.06. The new assembly should be preferably be represented and stored in the form of an location or assembly “object” (using prudent object-oriented techniques) which supports a relationship between data and functionality. The component set is then attached to the new assembly at 1220.08. The new assembly is then added to the model's assembly array at 1220.10, after which all data can then be stored in the database 108. Global searches can be performed on assembly objects using an location object ID or an assembly object ID.

2. Zones

The process of creating zones begins at 1230.02. The element set is read in at 1216.02 and the component set is read at 1216.04. The read-in steps can use an ASCII file, the database 108, the GUI, or some other means for inputting/collecting the data. If both the element and component sets are null, the process terminates. If either set is not null, the process proceeds to the creation of a new location at 1230.04. The new location should be stored in the form of a location or zone “object” consistent with object-oriented design practices. All information in the “object” should be initialized at 1230.04. The various element sets and component sets can then be attached to the new location at 1230.06. The zone can then be created at 1230.08 by reorganizing the elements and components to define the created zoned explicitly in terms of components. At 1230.10, the newly created zone location is added to the model's zone array to facilitate global searches by zone ID. The location (zone) objects can then be saved, with all data being saved to the database 108.

3. Joints

The process of creating a joint begins at 1240.02. The joint centroid can be read at 1218.02. This can be done through a binary database, an ASCII file, a GUI, or some other means. At 1218.04 the joint size/boundary (e.g. length, width, and height in the case of a rectangular prism) can be input into the system 100. This input process can also be done through either a binary database, an ASCII file, the GUI, or some other means. The system 100 can support a wide range of different volumetric boundaries. Accordingly the mathematics used for finding the intersection between the joint volume and the elements and/or components can also vary. At 1218.06 the component set, if such a set exists, is read into the system 100 from sources similar to the prior read steps. If no data is provided as to either volume or the component set, the process ends. Otherwise, the process continues to the creation of a new location at 1240.04. This preferably involves the creation of a location or joint “object” consistent with prudent object-oriented design techniques. All information for the object should be initialized. At 1240.06, all data relating to the joint 138 should be attached to the joint object, such as volumetric boundary, component sets, etc. At 1240.08 the joint 138 is created by reorganizing the elements and components to define the prescribed joint expressly in terms of components. The new joint 138 location should then be saved to the model's joint and/or location array to facilitate global searches by joint and/or location ID. The object should be saved, and all data saved to the database 108.

F. Creating Zones

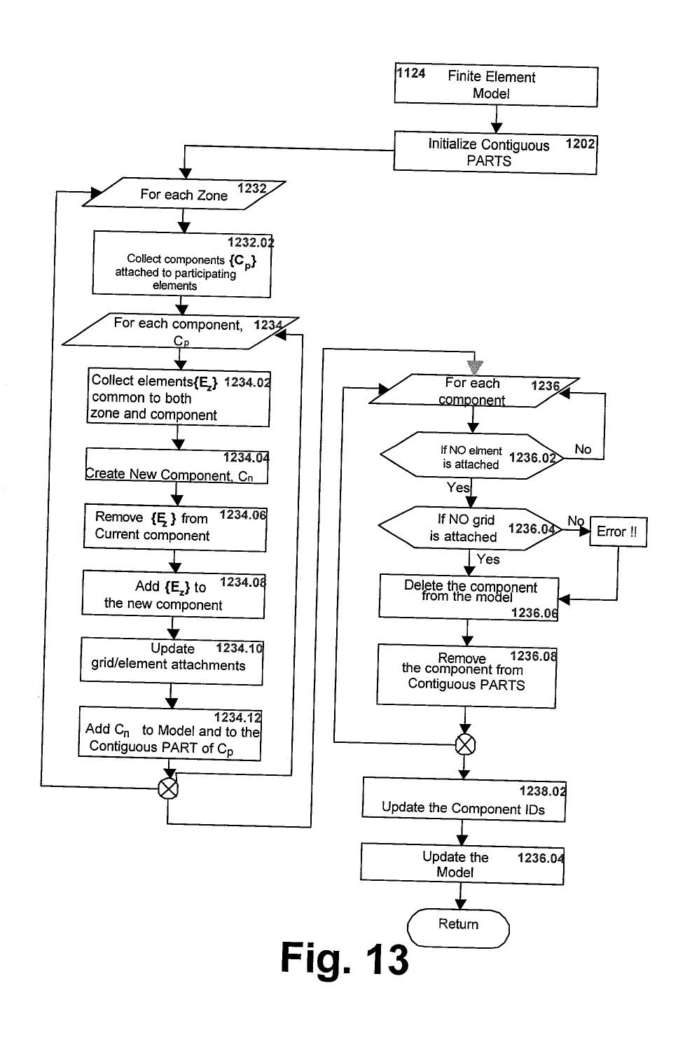

FIG. 13 is a more detailed flowchart illustrating one example of the zone creation process. The finite element model at 1124 can be input as an ASCII file, a binary database, or some other source. At 1202 the model 120 is initialized for contiguous parts 124. The loop at 1232 is performed for each zone. At 1232.02, the unique set of component IDs (Cₚ) that are associated with the element set(s) of the zone are found.

The loop at 1234 is then performed for each component (e.g. by component ID). At 1234.02, all elements (E_{z}) common to both the zone and the component are identified and collected. A new component (Cₙ) is created at 1234.02 with all of its data initialized. The common elements (E_{z}) can then be removed from the current component at 1234.06 and added to the new component (Cₙ) at 1234.08. Grid-element-component attachments in the model database 108 and the associated component database should be updated at 1234.10. At 1234.12, the new component (Cₙ) and the contiguous part assembly to which the component belongs are added to the model 120.

The loop at 1236 is then performed for each new component (Cₙ). If no element is attached (e.g. participates in the component) at 1236.02, the process for that new component ends. If there is at least one element that participates in the component, the number of participating elements (Nₑ) is greater than zero, and the process continues to 1236.04 where a determination is made if there are grids attached. If grids are attached, there is an error and the grids should deleted. The removal of the elements and grids from the component must have been erroneous and the loop ends for that particular new component with the deletion of the component. At 1236.06 the component and its references are deleted from the model database 108. At 1236.08, the component and its references are deleted from the contiguous parts. At 1238.02, the component Ids and their references are updated in the database 108. The model database is updated at 1238.04.

G. Creating Joints

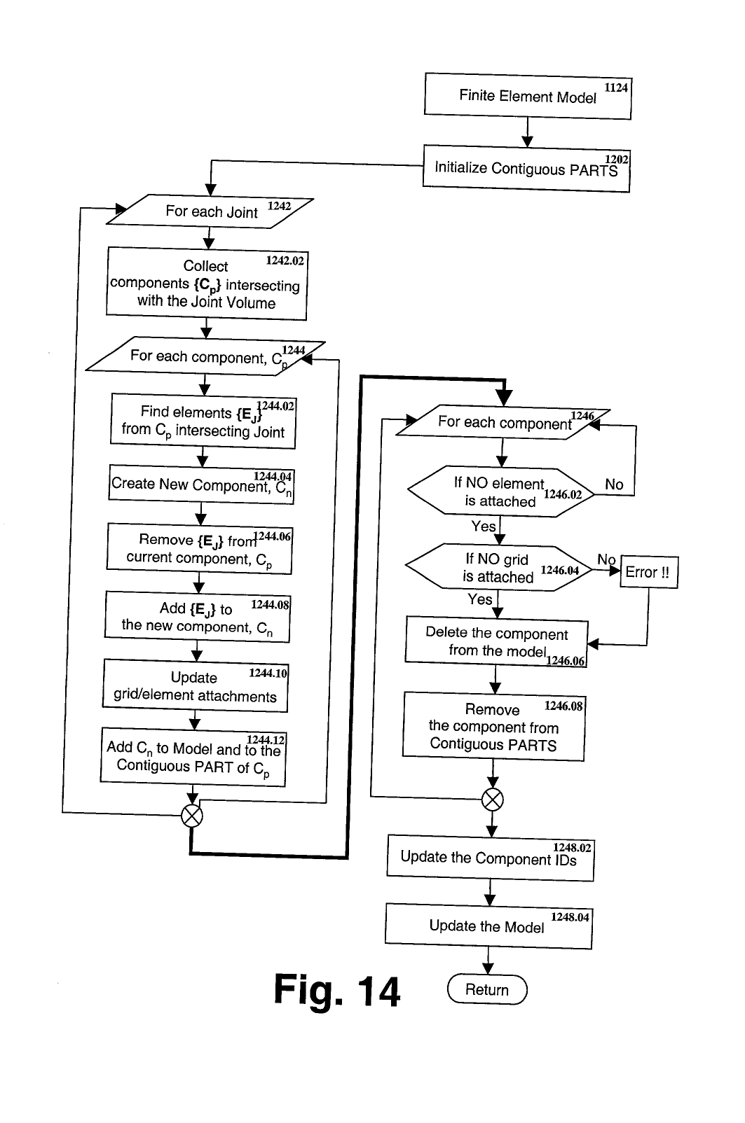

FIG. 14 is a detailed flowchart illustrating one example of a process for creating joints 138, one type of model location 180 in the system 100. The finite element model at 1124 can be input as an ASCII file, a binary database, or some other source. At 1202 the model 186 is initialized for contiguous parts 124. If there are no parts 124, a location or joint object is created for each component and the component is attached to the location or joint object. If there are parts, the existing parts array should be checked for accuracy with respect to the existing components in the model 120. No parts object should have an empty list of components. Each component referred to in every parts object should be a valid component in the current model 120.

The loop at 1242 is performed for each joint. At 1242.02 the volume boundaries and center of gravity for each component volume is compared with those of the joint volume under consideration. All components with boundaries that intersect with the joint boundary for are identified and collected.

The loop at 1244 is performed for each identified component (Cₚ) with boundaries that intersect, i.e. the loop sorts the elements of each component (Cₚ) participating in the joint 138. At 1244.02 the system 100 identifies and collects the elements (Eⱼ) of the current component (Cₚ) that intersect or participate in the joint 138. A new component (Cₙ) is then created at 1244.04 with all data initialized. At 1244.06 the participating elements (Eⱼ) are removed from the current component (Cₚ) and added to the new component (Cₙ) at 1244.08. Grid-element-component attachments in the model database 108 and the associated component database are updated at 1244.10. The new component (Cₙ) and its contriguous parts are added to the model 120 at 1244.12.

For each new component (Cₙ) the loop beginning at 1246 is performed. At 1246.02 the system 100 checks for the number of elements (Nₑ) participating in each component. If at least one element participates in the component (Nₑ>0), retain the component and proceed on to check the next component. If no element participates in the component, the system 100 then checks for attached grids. At 1246.04 the system 100 checks for the number of grids (N_{g}) attached to the component. If some grids are attached to the component (N_{g}>0), a fatal error is triggered that the removal of the elements and grids from the component in the process of building the joint components was erroneous. The component can then be deleted. If no grids are attached to the component, the removal of the elements and grids from the component in the process is “clean” the component is deleted. At 1246.06, the component and its references are deleted from the model database. At 1246.08, the component and its references are deleted from contiguous parts. At 1248.02, component IDs and their references in the model database are updated. At 1248.04, the model database is updated.

H. Location Energy Analysis

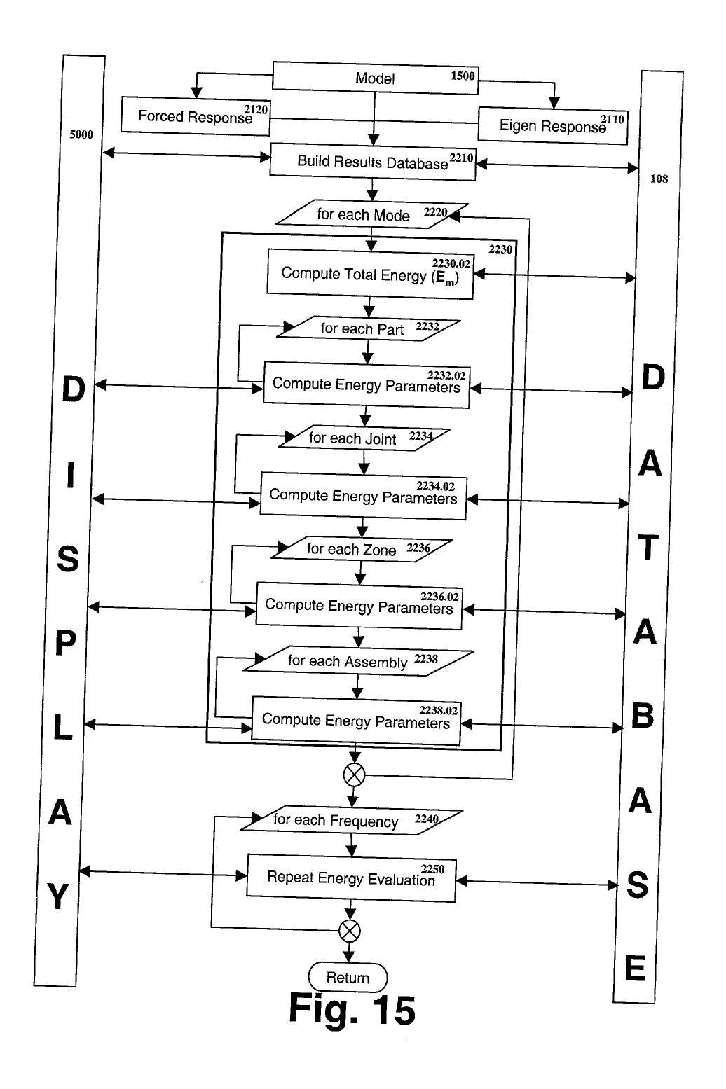

FIG. 15 is a flowchart illustrating one example of an energy analysis process that can be used by the system 100. The process identifies interesting (potentially critical) locations in the structural assembly. In a preferred embodiment, a conventional finite element analyzer is used for generating the results.

At 1500, a processed finite element model (can also be referred to as an “initial model”) 186 is inputted into the process. Preferably, component location descriptions and fastener location descriptions have been inputted into the system 100, but this is not a requirement.

At 2110, Eigen-value response solutions are generated for the initial (e.g. processed) model 186. These solutions are preferably obtained from a interfacing conventional finite element analyzer, although alternative embodiments may incorporate such functionality within the system 100 itself. At 2120, a force response is generated from similar finite analyzer means as above. At both 2110 and 2120, the data needed to invoke the response solutions are generated by the system 100

A results database is built in the looping process at 2210. The eigen-value solution is read and saved in the database 108. The force response is read and saved in the database 108. The output subsystem 5000 can be used to display the results stored in the results database, in a graphical and highly interactive manner.

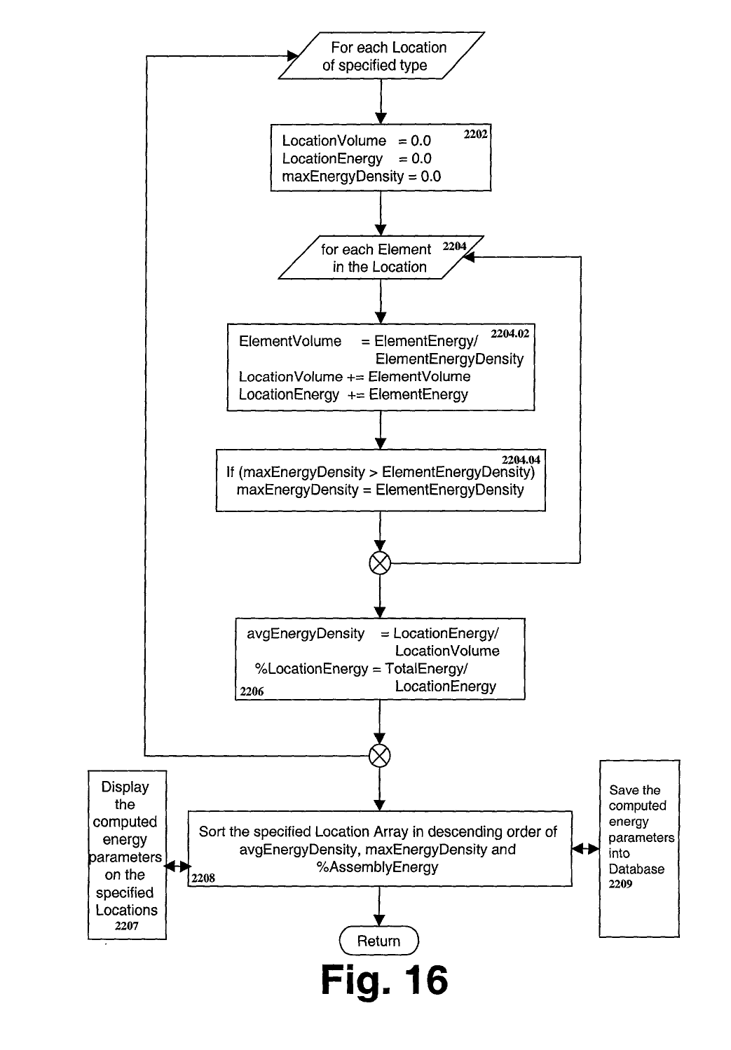

At 2220, the energy parameters for the specified parts 124, joints 138, zones 134, and assemblies 122 for each mode can be computed, resulting in an update of the database 108. An energy parameter module 2230 performs this functionality. At 2230.02 the total energy stored in the model (Eₘ) is computed by summing up all of the energy stored in all of the elements contained in the model 120. At 2232, energy parameters for each part in the model are calculated. One example of a compute energy parameters process at 2232.02 is illustrated in greater detail in FIG. 16. The total strain energy stored in the part (Eₚ)=sum of the strain energies stored in all the elements of the part (ΣEₑ). The maximum strain energy density for the part (eₚₘ)=maximum of the strain energy density values for the part elements (max(eₑ)). The average strain energy density for the part (eₚₐ)=average of the strain energy density values for the part elements (avg(eₑ)). The percentage strain energy for the part is (% Eₚ)=100*Eₚ/Eₘ. All of these calculations are examples of energy characteristics.

Returning to FIG. 15, similar calculations are performed at 2234.02 for each joint 138. FIG. 16 illustrates a detailed example of an energy evaluation for a particular location. The total strain energy stored in the joint (Eⱼ)=sum of the strain energies stored in all the elements of the parts of the joint (ΣEₚ). The maximum strain energy density for the joint (eⱼₘ)=maximum of the strain energy density values for the joint parts (max(eₚₘ)). The average strain energy density for the joint (eⱼₐ)=average of the strain energy density values for the part elements (avg(eₚₐ)). The percentage strain energy for the joint is (% Eⱼ)=100*Eⱼ/Eₘ. All of these calculations are examples of energy characteristics.

Returning to FIG. 15, similar calculations are performed at 2236.02 for each zone 134. FIG. 16 illustrates a detailed example of an energy evaluation for a particular location. The total strain energy stored in the zone (E_{z})=sum of the strain energies stored in all the elements of the parts of the zone (ΣEₚ). The maximum strain energy density for the zone (e_{zm})=maximum of the strain energy density values for the zone parts (max(eₚₘ)). The average strain energy density for the zone (e_{za})=average of the strain energy density values for the zone parts (avg(eₚₐ)). The percentage strain energy for the zone is (% E_{z})=100*E_{z}/Eₘ. All of these calculations are examples of energy characteristics.

Returning to FIG. 15, similar calculations are performed at 2238.02 for each assembly 122 in the model. FIG. 16 illustrates a detailed example of an energy evaluation for a particular location. The total strain energy stored in the assembly (Eₐ)=sum of the strain energies stored in all the elements of the parts in the assemby (ΣEₚ). The maximum strain energy density for the assembly (eₐₘ)=maximum of the strain energy density values for the assembly parts (max(eₐₘ)). The average strain energy density for the assembly (eₐₐ)=average of the strain energy density values for the assembly parts (avg(eₚₐ)). The percentage strain energy for the assembly is (% E_{z})=100*E_{z}/Eₘ. All of these calculations are examples of energy characteristics.

At 2440 the energy parameters for the specified parts 124, joints 138, zones 134, assemblies 122, and other locations, are computed at each solution frequency (force response) and the database 108 is updated. The energy evaluation described above is is repeated at 2250 for all locations with a different characteristic such as solution frequency (force response) or other useful characteristics.

I. Location Stress Analysis

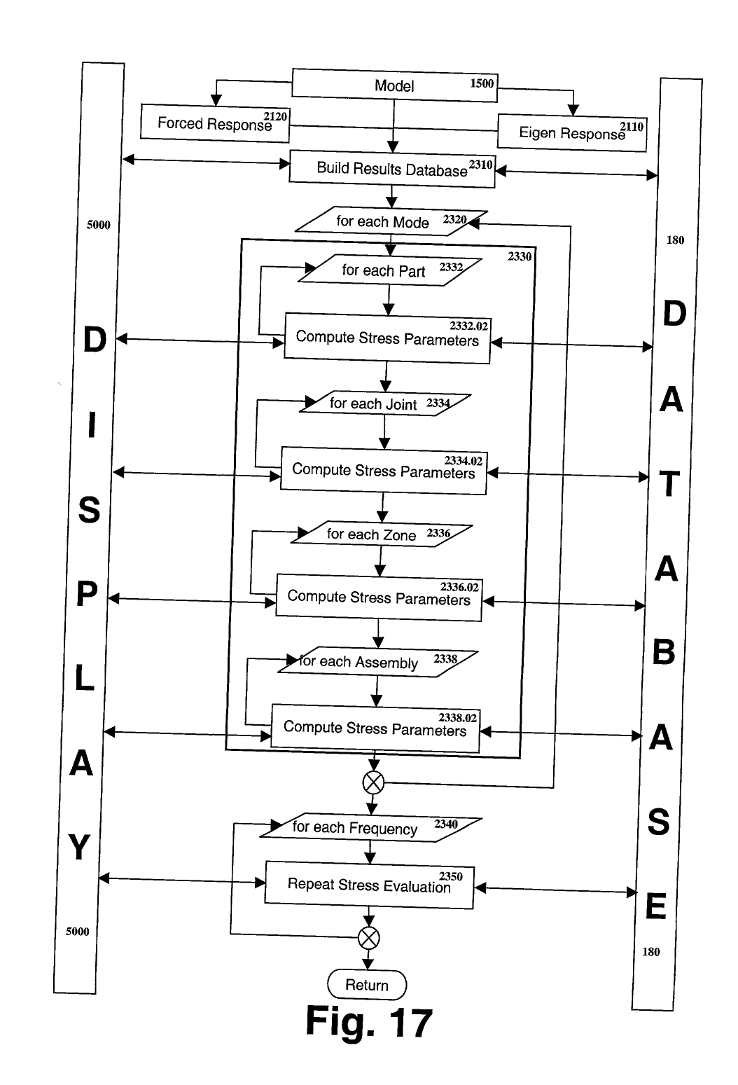

FIG. 17 is a flowchart illustrating one example of a location stress analysis that can be performed by the system 100. The process identifies interesting (potentially critical) locations from a stress distribution point of view for preferably all of the different location types. If desired, the system 100 can interface with an external finite element analyzer to perform the calculations.

The processed/initial model 186 is inputted at 1500. At 2110 the system 100 writes the eigen-value solution data for running the finite element analyzer. The Eigen-value solution (modal stresses) for the model 186 are then generated. At 2120, the frequency response solution data for running the finite element analyzer is written, generating the forced response (stresses) for the model. As discussed above, it is preferred for the system 100 to interface with a conventional finite element analyzer, although conventional finite element analyzer functionality can be incorporated into the system 100.

At 2310, the Eigen-value solutions for the model are read and the database 108 is updated with the results. The forced response(s) for the model are read and the database 108 is update the results. At 2320, the system 100 computes the stress parameters for the specified parts, joints, zones and assemblies for each mode, and then updates the database 108. At 2330, the system 100 computes the stress parameters for each part, joint, zone and assembly in the model and then updates the database 108.

At 2332, the system 100 computes the stress parameters for each part of the model 120. At 2332.02, the system 100 computes the stress parameters for a particular location (the calculation is described in greater detail in FIG. 15). The database 108 is updated with part stress parameters.

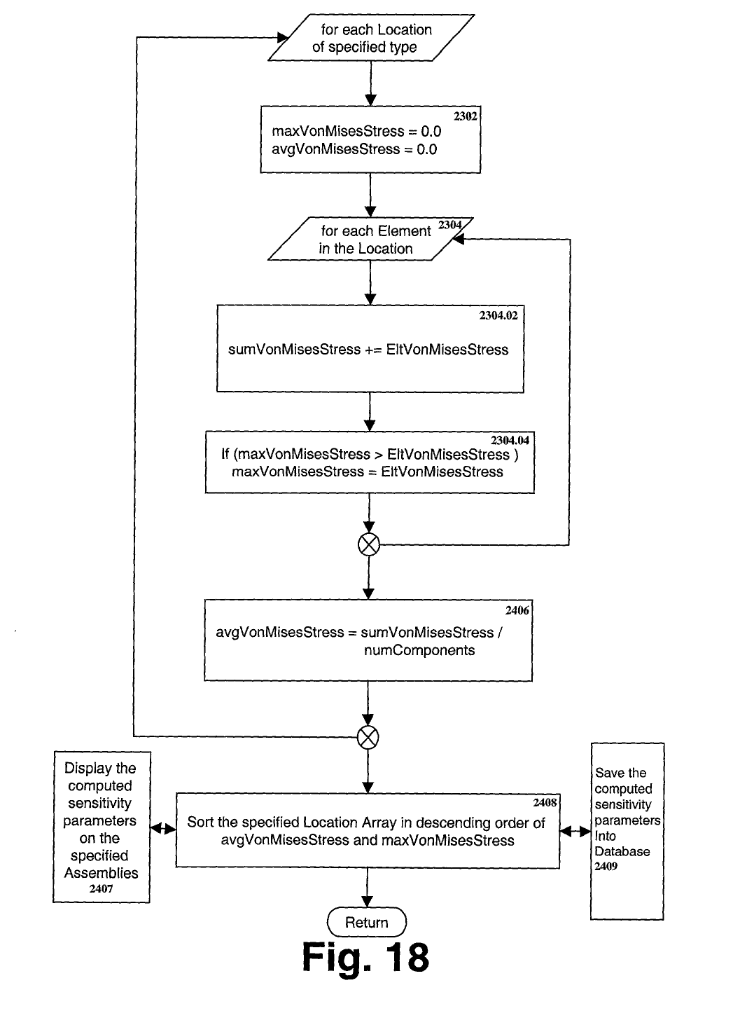

At 2334, the system 100 compute the stress parameters for each joint of the model 120. The calculation is described in greater detail in FIG. 18.

At 2336, the system 100 computes the stress parameters for each zone of the model 120. The calculation is described in greater detail in FIG. 18.

At 2338, the system 100 computes the stress parameters for each assembly of the model 120. The calculation is described in greater detail in FIG. 18.

At 2340, the system 100 computes the stress parameters for the specified parts, joints, zones, assemblies, and other locations at each solution frequency (forced response). This process parallels the preceding steps from 2320 through 2338. All results should be saved to the database 108. and update the database 108.

J. Location Sensitivity Analysis

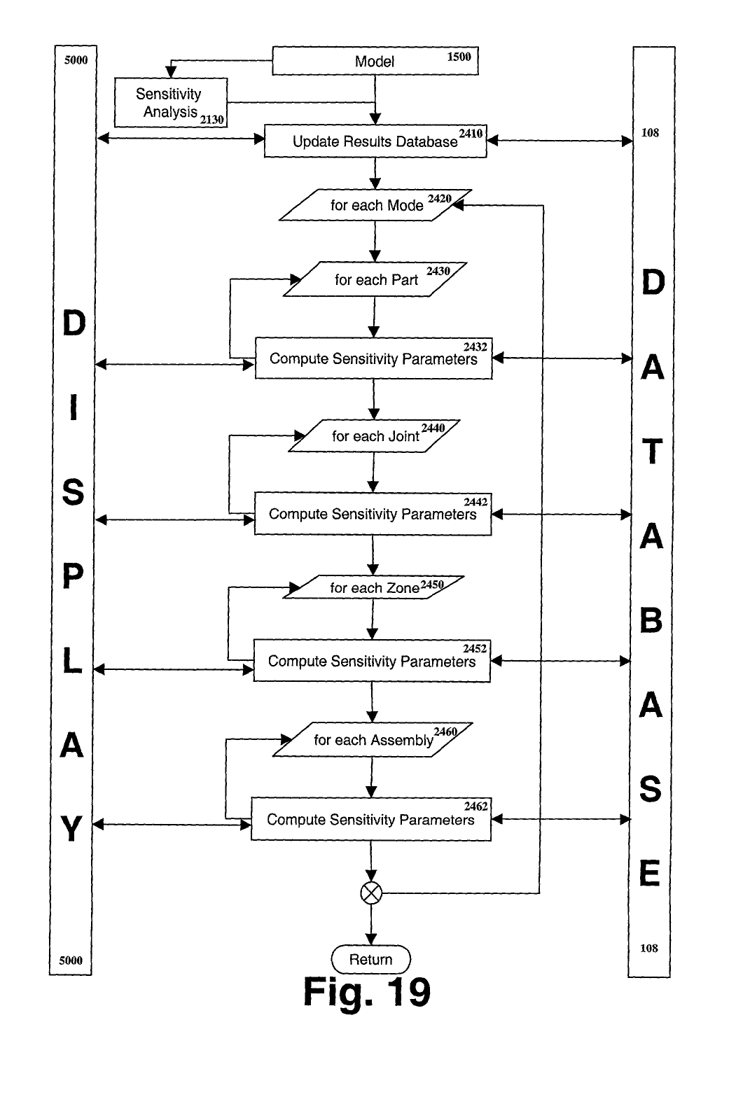

FIG. 19 is a flowchart illustrating one example of the processing that can be performed by the system to evaluate sensitivity characteristics. This process can identify interesting (e.g. potentially interesting) locations in the model with respect to sensitivity characteristics.

At 1500, the processed/initial model 186 is inputted to the process. At 2130, the sensitivity solution data is written for invoking finite element analyzer functionality. Part sensitivity indices for the model can be generated using the finite element analyzer functionality, whether internal or external to the system 100.

At 2410, the system 100 reads the part sensitivity indices for the model 120, and updates the database 108. At 2420, the system 100 computes the sensitivity parameters for the specified parts, joints, zones and assemblies, and then the database 108 is updated.

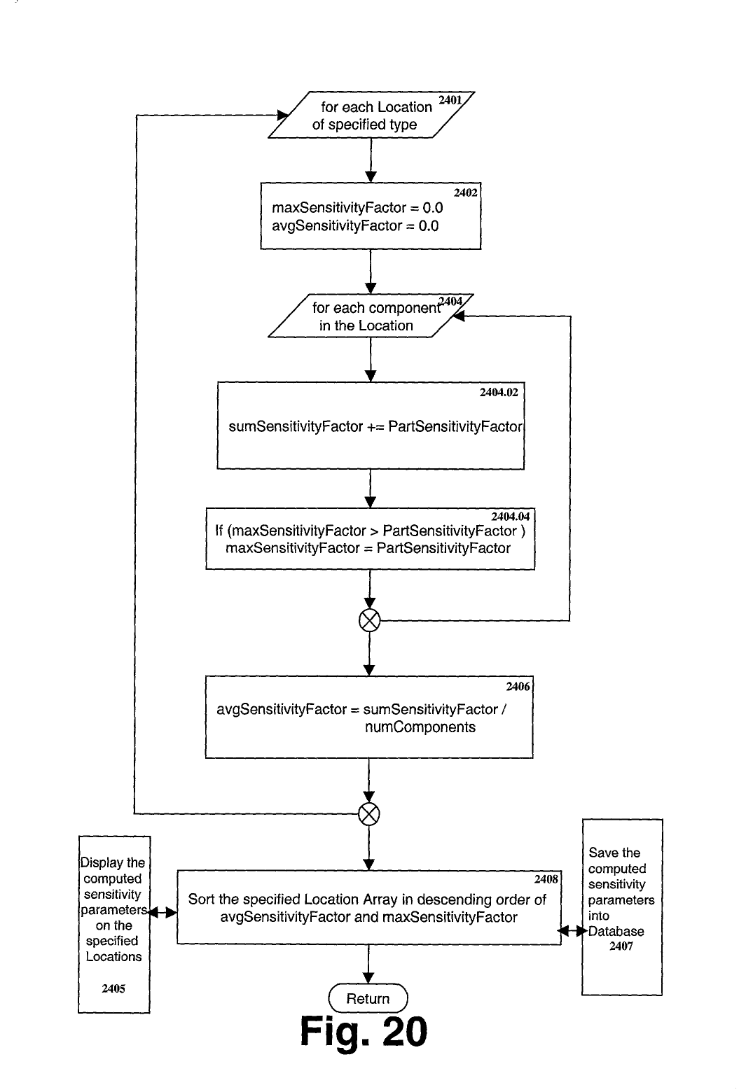

At 2430, the system 100 computes the sensitivity parameters for each part of the model 120. The system 100 computes the sensitivity parameters for a particular part. FIG. 20 discloses the process for computing sensitivity parameters (characteristics) for a specific location. All results should be saved and updated on the database 108.

At 2420, the system 100 computes the sensitivity parameters for each joint of the model. FIG. 20 discloses the process for computing sensitivity parameters (characteristics) for a specific location. All results should be saved and updated on the database 108.

At 2450, the system 100 computes the sensitivity parameters for each zone of the model. FIG. 20 discloses the process for computing sensitivity parameters (characteristics) for a specific location. All results should be saved and updated on the database 108.

At 2460, the system 100 computes the sensitivity parameters for each assembly of the model. FIG. 20 discloses the process for computing sensitivity parameters (characteristics) for a specific location. All results should be saved and updated on the database 108.

K. Component Enhancement

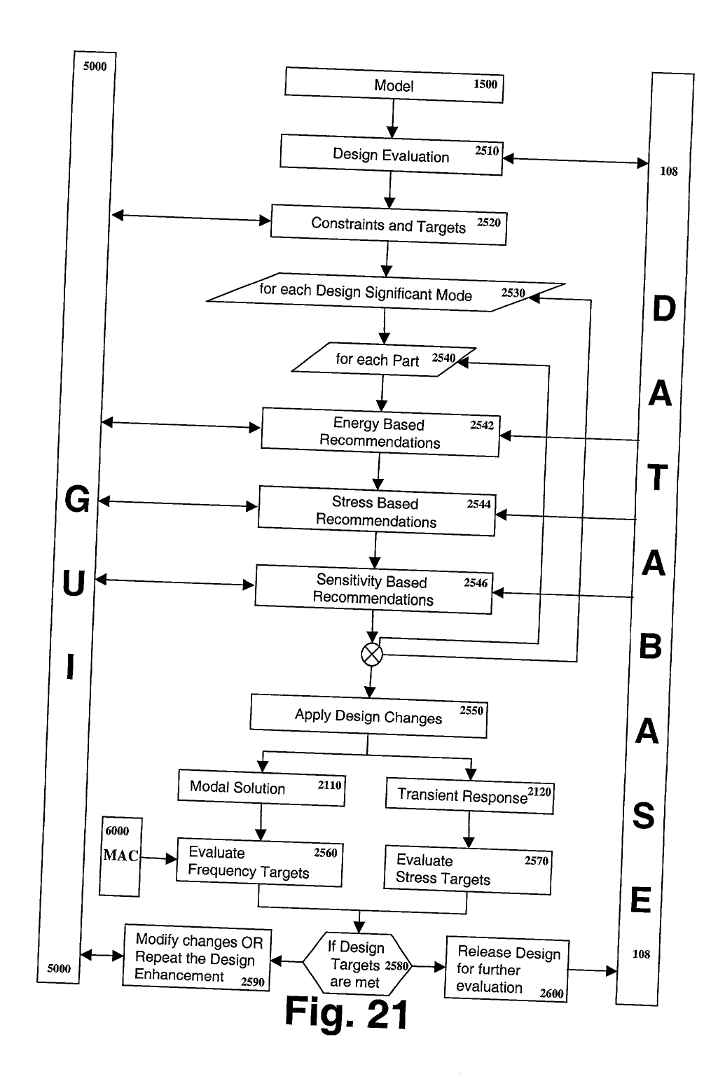

FIG. 21 discloses a flowchart illustrating one example of a component (e.g. design) enhancement process that can be performed by the system 100.

At 1500, the processed model 186 is the input for the process. The model 186 should be processed with respect to design locations (e.g. component locations 183) but need not be processed with respect to fastener locations 184.

At 2510, the system 100 performs a design (e.g. component) evaluation, an evaluation of energy and stress distribution in each part as well as the sensitivity of each part for each design-significant mode/frequency. There are a number of constraints and targets at 2520 that are preferably provided by the user 102. In alternative embodiments, the system 100 as discussed above provides the target and constraint information.

A preferred embodiment has the following constraints:

1. The thickness tₚ of each part p should be within the range manufacturing limits min.tₚ and max.tₚ.

2. The overall mass of the structure mₛ should not exceed it maximum limit, max.mₛ.

3. The mass mₚ of each part p should not exceed maxmₚ.

4. The m number of design significant modes of the structures belongs to {M}.

A preferred embodiment has the following targets/goals (“target constraints”):

1. The frequency fₘ of each significant mode m should be greater than min.fₘ.

2. The maximum stress σₚ in any part should not exceed the corresponding allowable limit, σₚ^{a}, which is computed from either the yield stress or the ultimate stress of the material of the part in practice.

At 2530, recommendations on component (e.g. part design) changes for each component (e.g. design) significant mode/frequency. At 2540, recommendations on design changes are established for each part. At 2542, recommendations on design changes are established for the part based on its energy distribution. Energy distribution is shown over the part as well as the relative energy content in the part when compared to its neighboring parts or entire structure to assist the user take appropriate decision of up-gauging, down-gauging and/or reinforcement.

At 2544, recommendations on design (e.g. component) changes are established for the part based on its stress distribution. Stress distribution is shown over the part as well as the relative stress level in the part when compared to its neighboring parts or entire structure to assist the user take appropriate decision of up gauging, down gauging and/or reinforcement.

At 2546, recommendations on design changes are established for the part based on its sensitivity to design significant mode. Sensitivity of the part is shown in contrast with that of the other parts of the structure to assist the user 102 feel the relative influence of the current part over the structural frequencies and take appropriate decision of up gauging, down gauging and/or reinforcement.

At 2550, desired design changes are extracted with the appropriate user 102 interaction. The structural mass is recomputed based on the new design. If the mass exceeds the target, prompt the user to reconsider the design changes. Otherwise, the modified model is created. The system 100 also generates solution requests for generating the eigen-values and the dynamic response for the modified model subjected to the same load and boundary conditions.

At 2110, the system 100 solves the modified model for its Eigen-value solution either from an established commercial finite element analyzer and read the results, or derive the solution internally by a built-in solver.

At 2560, the system 100 reads the Eigen-value solution for the modified model and compare the same with he original model. The system 100 then establishes the frequency change in the modified design when compared to the original model for each significant mode previously identified by the user 102.

At 2120, the system 100 solves the modified model for its dynamic response either from an established commercial finite element analyzer and read the results, or derive the solution internally by a built-in solver. It is preferable to use the same load and boundary conditions.

At 2570, the system 100 reads the dynamic response for the modified/enhanced model and compare the same with the original model. The system 100 establishes the change in critical stress level in each part in the modified/enhanced model when compared to the processed model.

At 2580, the system 100 evaluates the Eigen solution and dynamic response of the modified model in comparison with that of the original model. If the modified/enhanced model has generally a higher frequency for all the modes, and all the modal targets are met, the user 102 could possibly accept the design modifications. Otherwise, the user 102 may make additional design changes and repeat the evaluation.

If the modified/enhanced model has generally a lower stress level in all the parts when compared to the initial/processed model, and if no part exceeds its allowable stress, the user could possibly accept the design modifications. Otherwise, the user 102 may make additional design changes and repeat the evaluation.

At 2590, the GUI allows the user to reconsider the design modifications. At 2600 the modified/enhanced model 120 is saved to the database 108.

L. Fastener Enhancement

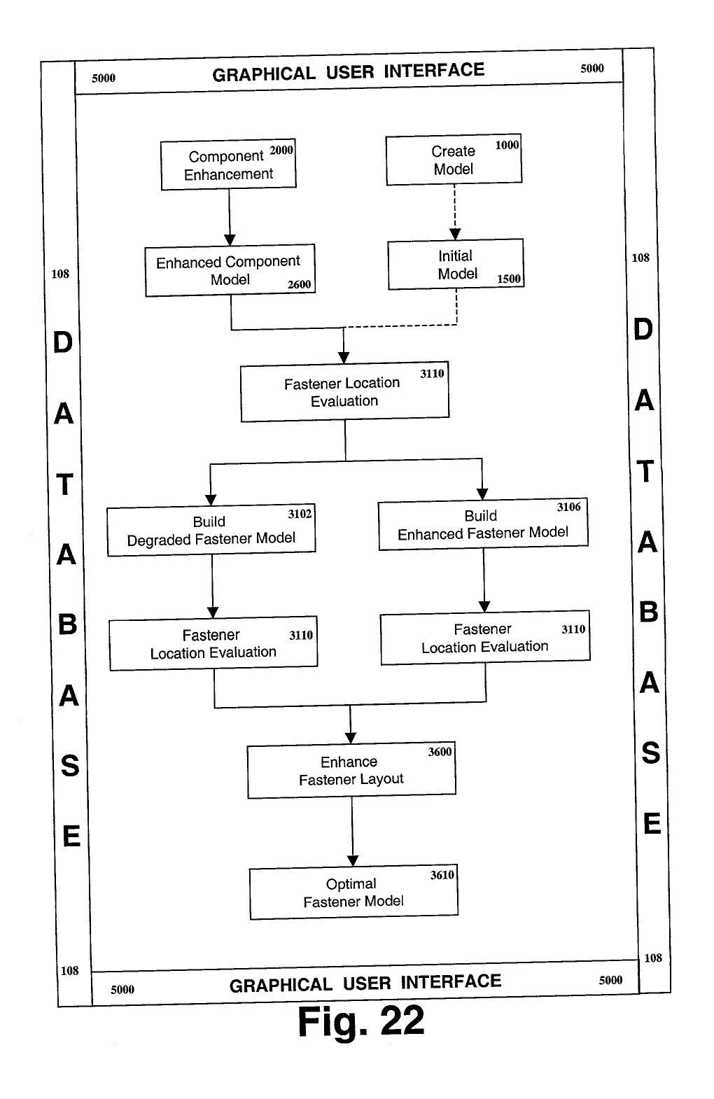

FIG. 22 discloses a flowchart illustrating one example of a fastener enhancement process that can be invoked by the system 100. The process of fastener enhancement can occur after part design enhancement at 2000 with a component enhanced model at 2600. However, such processing is not required. The fastener enhancement process can also be invoked from a processed model at 1500.

At 3110, the system 100 evaluates the fastener locations of the specified model with regards to strength, lifespan, and other characteristics. The system 100 generates the parameters (e.g. characteristics) for comparative evaluation of the fasteners over the model 120. The system 100 also computes the parameters for comparing different models for their fastener efficiency as well as structural dynamic characteristics.

At 3102, the system 100 creates the fastener-degraded model (3104) from the processed model 1500 by increasing the fastener spacing in the vicinity of the critical fastener locations.

At 3106, the system 100 creates the fastener-upgraded 196 or enhanced model 190 (3104) from the processed/initial model (1500) by decreasing the fastener spacing in the vicinity of the critical fastener locations 182.

At 3600, the system 100 compares the fastener-degraded model (3104) with the processed/initial model (1500) and evaluates the degradation in structural dynamic characteristics as well as the critical fastener strength and life. The system 100 can also compare the fastener-upgraded model (3108) with the processed model (1500) and evaluate the enhancement in structural dynamic characteristics as well as the critical fastener strength and life.

At 3610, the system 100 retains the fastener space enhancements in the locations that show significant improvement, and enhance the fastener spacing at the critically degraded fastener locations (if they are not already enhanced) to come up with the optimal fastener layout for the model. If allowed, increase the fastener spacing at the significantly non-critical (from strength, life and dynamic characteristics points of view) fastener 128 locations as well.

M. Fastener Location Evaluation

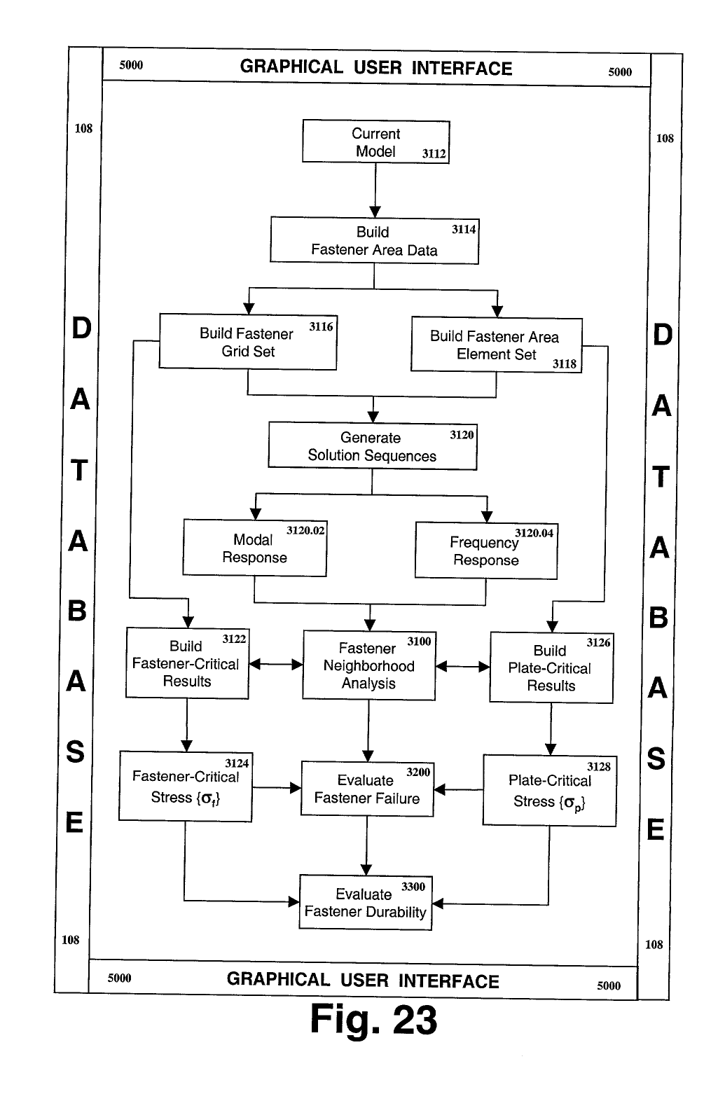

FIG. 23 is a flowchart of a fastener location evaluation process that can be invoked by the system 100.

At 3112, the current model under consideration for fastener evaluation is the input for the process. It could be design-enhanced model (2600) or the processed model (1500) or the fastener-degraded model (3104) or the fastener-upgraded model (3108).

At 3114, the system 100 compiles the data regarding the nodes, elements and parts attached to each fastener for which the finite element results are sought and further fastener evaluation is conducted.

At 3116, the System 100 collects all the force recoverable fastener nodes to a set for which the multipoint constraint forces are sought through a finite element solution. The set of all duplicate nodal reference can then be cleaned.

At 3118, the system 100 collects all the continuum elements attached to the fastener nodes into a set for which the stresses are sought through a finite element solution. In alternative implementations, the system 100 could also consider the continuum elements attached to the immediate continuum neighborhood of the fastener nodes. The set of all duplicate element references can then be cleaned.

At 3120, the system 100 generates solution sequences for the model being processed to generate eigen-value solutions and dynamic response to specified loads with solution output requests for stresses at the fastener location elements and multipoint constraint forces at the fastener nodes.

At 3120.02, the system 100 generates Eigen value solutions for the specified model (3112). In a preferred embodiment, the solutions are imported from an interfacing finite element analyzer.

At 3120.04, the dynamic response solution for the specified model (3112) is generated by a finite element analyzer, whether internal or external to the system 100.

At 3100, the failure and life for each fastener location is evaluated from weld, plate, and other points of view. Critical fastener locations are identified.

At 3122, multipoint constraint forces are read at all the pre-selected fastener nodes and compute the critical stress for each frequency/mode {σ^{f}_{f}}. In case of dynamic response, transform the frequency domain critical stress field into time domain using standard or indigenous transformations {σ^{t}_{f}}.

At 3126, the element stresses are read at all the pre-selected fastener location elements and the critical stress for each frequency/mode {σ^{f}ₚ} is computed. In case of dynamic response, transform the frequency domain critical stress field into time domain using standard or indigenous transformations {σ^{t}ₚ}.

At 3200, the system 100 finds the maximum critical fastener stress (max.σ^{f}_{f}) for each frequency/mode. In case of dynamic response, the maximum critical fastener stress (max.σ^{t}_{f}) as found as well. The system 100 compares the maximum stress with the corresponding allowable to evaluate the failure of the fastener. The maximum critical fastener area stress (max.σ^{f}ₚ) is identified for each frequency/mode. In case of dynamic response, the maximum critical fastener stress (max.σ^{t}ₚ) is preferably also determined. The system 100 can then compare with the maximum stress with the corresponding allowable to evaluate the failure of the fastener.

At 3300, the system 100 can carry out standard fatigue life evaluation on {σ^{t}_{f}} to evaluate the life for each fastener (L_{f}). The critical fastener fatigue life, max.L_{f} can also be computed. A standard fatigue life evaluation can be performed on {σ^{t}ₚ} to evaluate the life for each fastener location (Lₚ) Similarly, the critical fastener fatigue life, max.L_{f} can also be computed for each fastener location max.Lₚ.

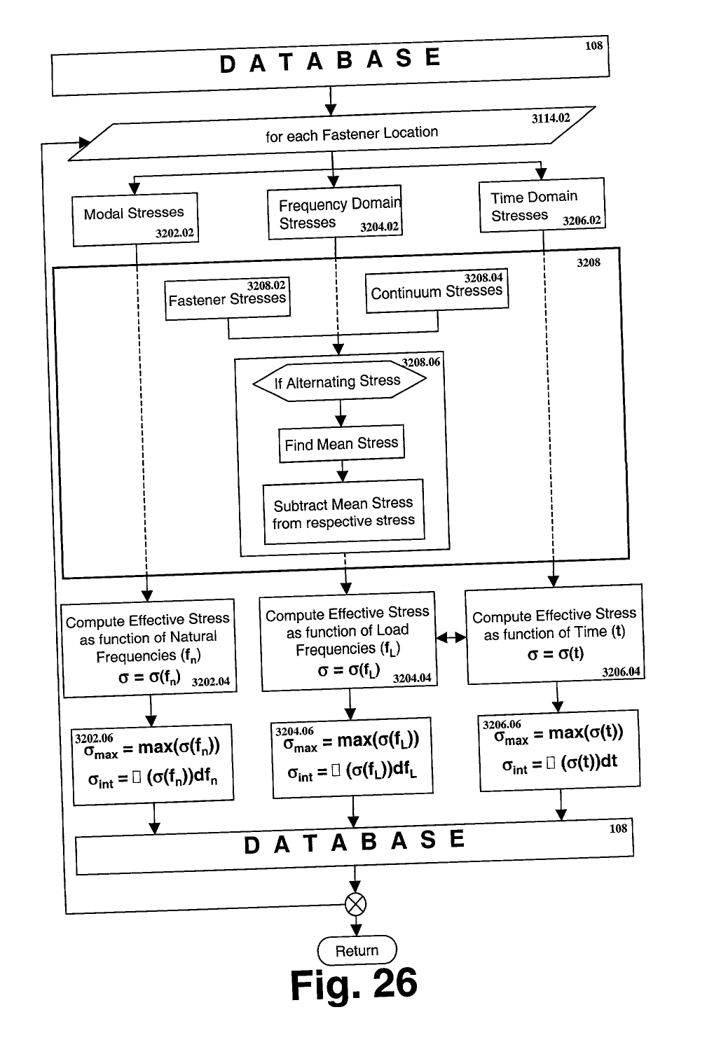

Some of the stress calculations identified above are disclosed in greater detail in FIGS. 26, 27, and 28.

N. Build Fastener Location Data

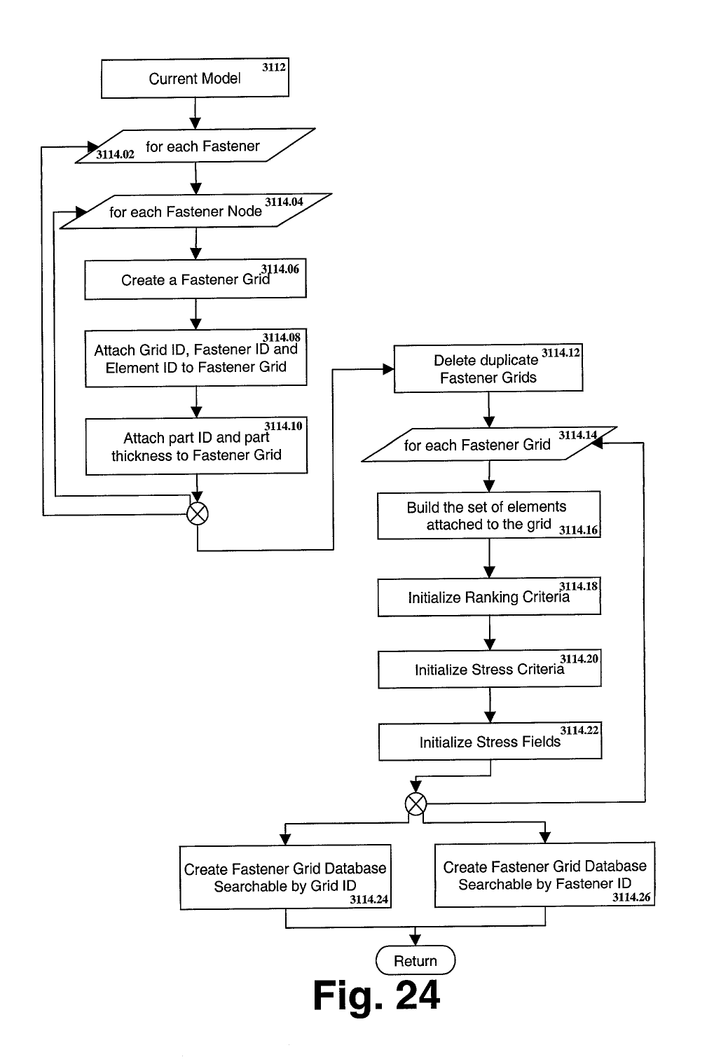

FIG. 24 is a flow chart illustrating one example of a build fastener location process. As mentioned above, model locations are the building blocks used by the system to evaluate model characteristics.

The model at 3112 is the current model under consideration for fastener evaluation. It could be design-enhanced Model (2600) or the processed model (1500) or the fastener-degraded model (3104) or the fastener-upgraded model (3108).

At 3114.02 data regarding the element, nodes and parts attached to each fastener is compiled. At 3114.04 the data regarding the element, the grid and the part attached to each fastener node. Is compiled. At 3114.06 a new data block for the fastener is created. At 3114.08 the Grid ID associated with the fastener node is added to the fastener grid data block. The fastener ID and the associated element ID are added to the fastener grid data block. At 3114.10 the system 100 finds the part attached to the fastener grid and adds them to the fastener grid data block. The part thickness is also added to the data block.

At 3114.12 the system 100 finds and deletes the duplicate fastener grid references and the associated fastener grid data blocks. At 3114.14 the fastener location is built. Fastener location results initialized for each fastener grid.

At 3114.16 the system 100 finds the continuum elements that are attached to the fastener grid directly or through any rigid/elastic links. As an extension, the system 100 can also consider the secondary continuum element attachments (the elements attached to the immediate continuum neighborhood).

At 3114.18 the ranking criteria is initialized as to whether the fastener locations are sorted and ranked based on the associated fastener stress or the associated continuum neighborhood stress or both. The default rule is to consider both and take the worst characteristic for each fastener location for subsequent processing

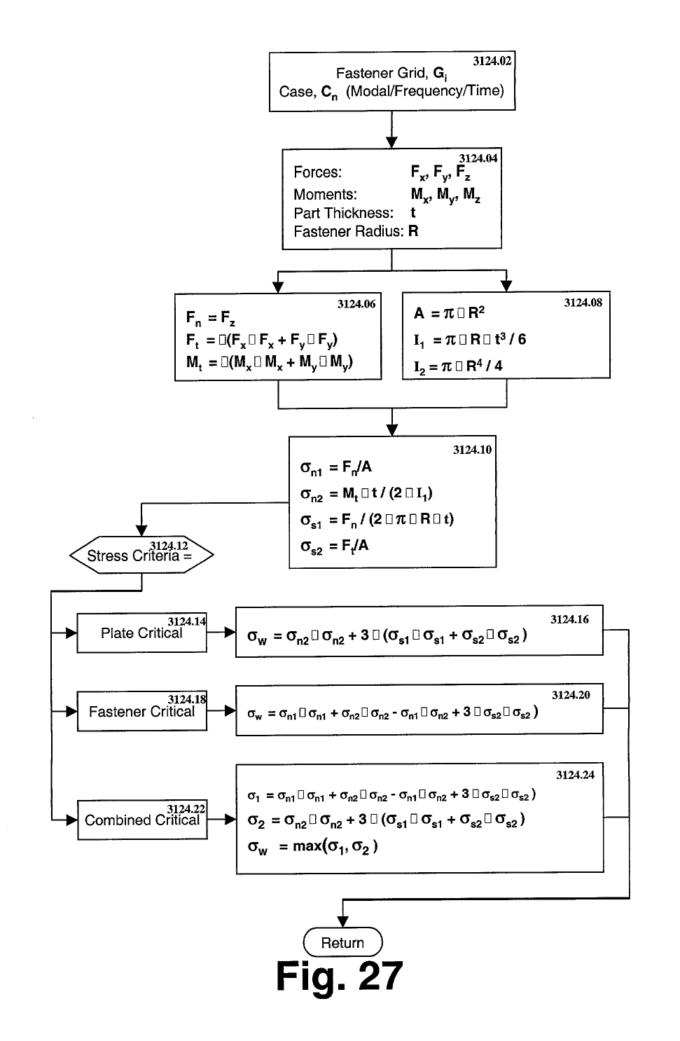

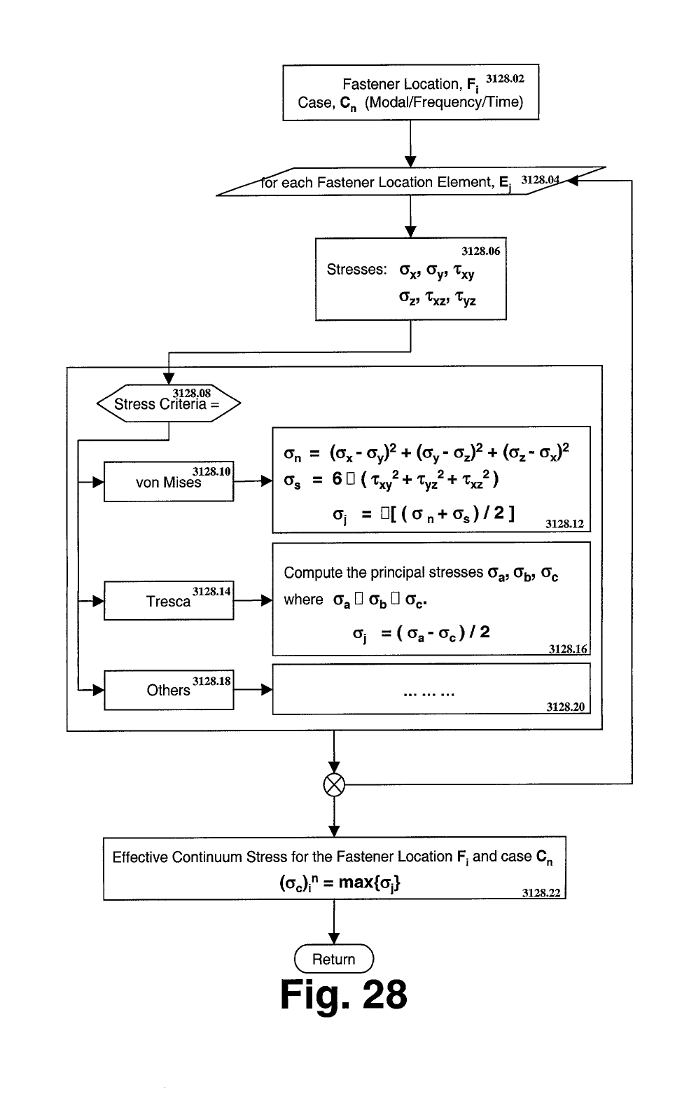

At 3114.20 stress criteria is initialized as to which stress parameter is considered for evaluating the failure stress (see FIG. 26) and failure life (see FIG. 27) at the fastener locations. By default an indigenous vonMises-equivalent stress parameters is used to evaluate the critical fastener stress field while the vonMises stress parameter is also the default computation used to evaluate the critical continuum stress (see FIG. 28) in the fastener area.

At 3114.22, the system 100 initializes the location stress field at the fastener grid and/or the continuum stress fields at the attached continuum elements depending on the initialized ranking criteria and the initialized stress criteria.

At 3114.24, fastener grid data blocks are organized to enable the search for data for a given fastener grid ID. At 3114.26 fastener grid data blocks are organized to enable the search for data for a given fastener ID.

O. Fastener Area Analysis

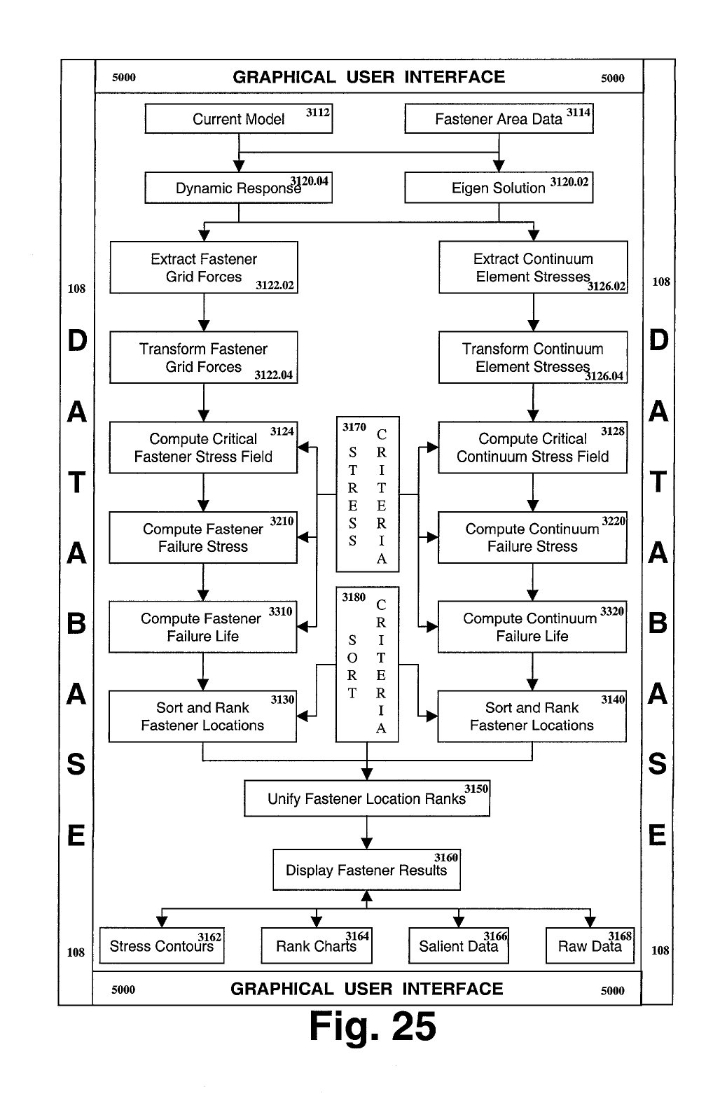

FIG. 25 is a flowchart illustrating one example of the types of processing that can be invoked to analyze fastener locations in terms characteristics relating to the neighborhood or vicinity of the fastener location (e.g. fastener area 140). FIGS. 26, 27, and 28 illustrate some of the specific computations in greater detail, but FIG. 25 provides a view of how the various computations can be used by the system 100.

At 3112 the process requires a current model 120 for analysis. It could be design-enhanced model (2600), the processed model (1500), the fastener-degraded model (3104), the fastener-upgraded model (3108), or other types of models 120 processed by the system 100.

At 3114, the system 100 compiles the data regarding the nodes, elements and parts attached to each fastener for which the finite element results are sought and further fastener evaluation are conducted.

At 3120.02, the Eigen-value solutions for the specified model (3112) are generated by a finite element analyzer, which can be either internal or external to the system 100 as described above. At 3120.04, the dynamic response solution for the specified model (3112) is generated by a finite element solve, which can be either internal or external to the system 100 as described above.

At 3122.02, fastener forces (multipoint constraint forces) are extracted from the solution for all the fastener grids at specified frequency/time values. At 3122.04, if the fastener forces (multipoint constraint forces) are in frequency domain (only for dynamic response), the system 100 transforms each degree of freedom into time domain using regular and/or indigenous transformations, e.g. Fast Fourier Transformation.

At 3124, the system the effective fastener stress is computed from the time domain fastener forces as depicted in FIG. 27. Any alternative expressions can be adapted for the purpose as well.

At 3210, the system 100 computes the fastener failure stress based on the maximum range of effective fastener stress as against the allowable stress limits provided by the user for the fastener material. FIGS. 26 and 27 reveal sample computations in greater detail.

At 3310, alternating stresses and the stress cycles from the effective fastener stress field in time domain are computed. Using regular methods adapted in standard durability evaluation, the system 100 computes the critical life for the fastener using the fatigue properties of the fastener material.

At 3130, the system 100 sorts the fasteners based on critical stress and rank each fastener from strength failure point of view. Fasteners can be sorted based on critical life and rank each fastener from life failure point of view.

At 3126.02, element stresses are extracted from the solution for all the fastener location continuum elements at specified frequency/time values.

At 3126.04, if the element stresses are in frequency domain (only for dynamic response), the system 100 transforms each stress component field into time domain using regular and/or indigenous transformations, e.g. Fast Fourier Transformation.

At 3128, the effective fastener location stress is computed from the time domain element stresses as depicted in FIG. 28. Any alternative expressions can be adapted for the purpose as well.

At 3220, fastener location failure stress based on the maximum range of effective fastener stress is computed against the allowable stress limits provided by the user for the associated part material. Refer to FIGS. 26 and 28 for the details of computing the continuum failure stresses.

At 3320, the system 100 computes the alternating stresses and the stress cycles from the effective fastener location stress field in time domain. Using regular methods adapted in standard durability evaluation, the critical life for the fastener location can be computed using the fatigue properties of the fastener material.

At 3140, fastener locations 184 based on critical stress and rank each fastener location from strength failure point of view. Fastener locations 184 should be sorted based on critical life and rank each fastener from a life failure point of view.

At 3140, the system 100 unifies the fastener ranks from the different ranking indices using standard weighted average techniques. At 3160, the system 100 can display fastener results to assist the user 102 take efficient decisions e.g. stress contours (3162), rank charts (3164), salient data (3166), raw data (3168), etc.

P. Compute Fastener Location Failure Life

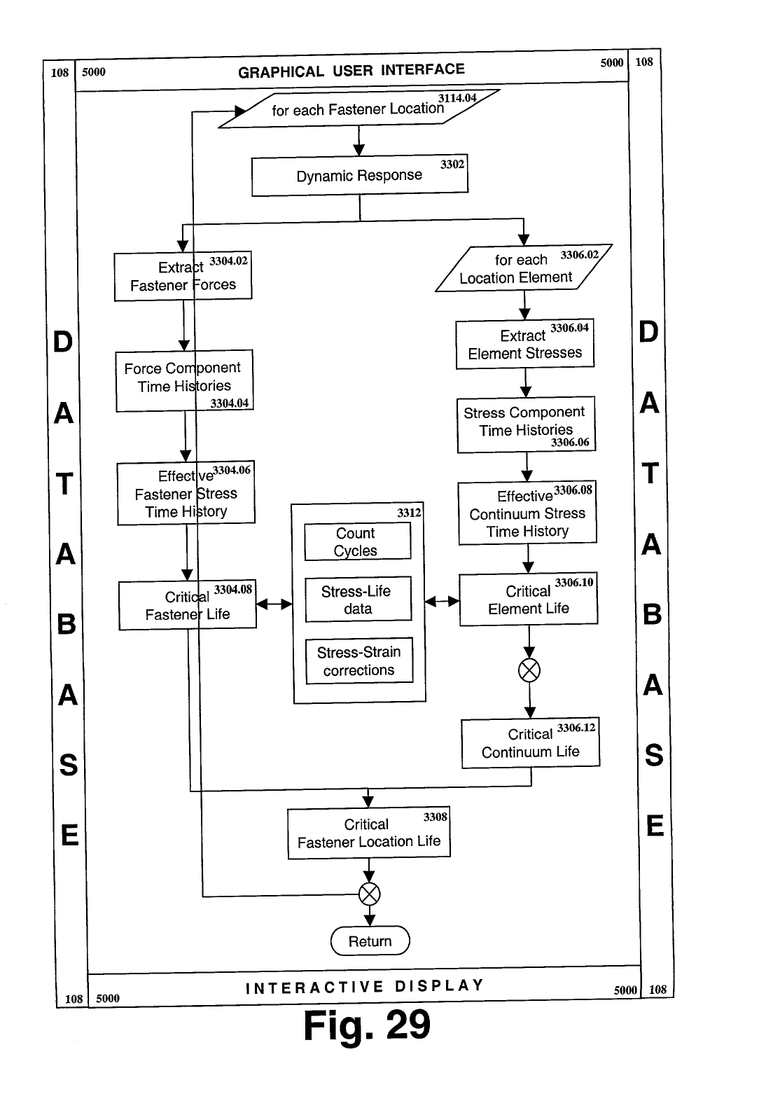

FIG. 29 is a flow chart illustrating one example of a process for computing the fastener location failure life. The process is performed on a fastener location by fastener location basis at 3114.04. The system 100 computes the critical failure life for each fastener location from the structure's dynamic response to a set of specified loads from various points of view. At 3302, the dynamic response solution for the structure is subjected to a specified load generated by an external/internal finite element analyzer.

At 3304.02, the system 100 can extract the fastener forces from the dynamic response solution for the structure subjected to the specified load. The force component fields transformed to the time domain (if required) are used to generate equivalent time histories for the force component fields at 3304.04.

Effective fastener stress time history can be computed at 2204.06 by computing the effective fastener stress at each time step (FIG. 27) from the corresponding fastener force components. The effective/critical life for the fastener are computed from its effective stress time history using standard durability evaluation process such as one depicted in 3312 or any other method at 3304.08.

The effective/critical life is computed for each fastener location at 3306.02. At 3306.04 element stresses are extracted from the dynamic response solution for the structure subjected to the specified load. The element stress component fields are transformed at 3306.06 to the time domain (if required) to generate equivalent time histories for the same.

The effective continuum stress time history are determined at 3306.08 by computing the effective continuum stress at each time step (FIG. 28) from the corresponding element stress components. At 3306.10, the system 10 can compute the effective/critical life for the element from its effective stress time history using any standard durability evaluation process such as one depicted in 3312 or any other method.

At 3306.12, the system 100 can assign the most critical element life in the fastener area as the critical fastener location life. At 3308, the system 100 can assign the more critical fastener location life of the two, critical fastener life and critical continuum life, as the critical fastener location life. Other embodiments can utilize weighted averages and other forms and combinations of characteristics.

A durability module at 3312 preferably: counts the number of alternating cycles in the effective field response; computes the alternating stress associated with each cycle; applies the stress/strain corrections (if any); and compares the stress level of each cycle with the material's stress-life data; evaluates the influence of each cycle on the structural life at the point of evaluation; and computes the effective life at the point of evaluation.

Q. Sort Locations

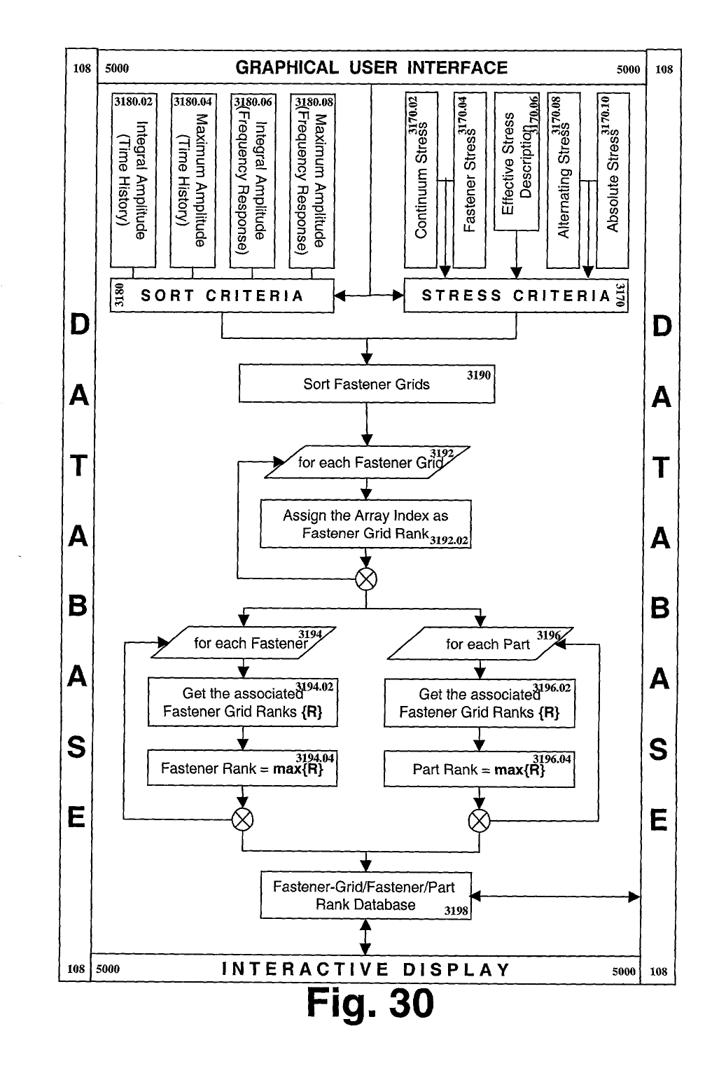

FIG. 30 is a flow chart illustrating one example of process for sorting fasteners and non-fastener locations. Locations can be sorted using a wide variety of different characteristics. Any characteristic that the system 100 can track can be used for sorting purposes.

At 3170, the system 100 uses stress criteria for evaluating the structural response (force/stress) in the vicinity of the fasteners and then sorts the fasteners from various points of view (e.g. a characteristic-based point of view). Other sorting method/combinations can be adapted. At 3170.02, the system 100 uses continuum stress, stress in the continuum evaluated from the basic stress response in the close vicinity of the fastener grids. At 3170.04, the system 100 uses fastener stress, stress in the fastener evaluated from the fastener forces. At 3170.05, any weighted combination of continuum and fastener stresses can be used. At 3170.06, an effective stress description using any standard generalized stress parameter such as von Mises, Octahedral, Tresca, Principal Normal, Principal Shear, and etc. or any indigenous description as depicted in FIG. 27 can be used by the system. At 3170.08, alternating stress, the effective fastener stress field that is first converted to a signal oscillating about the mean of the result field distribution by computing the field mean and subtracting the same from the whole response, is used to sort the various locations. At 3170.10 absolute stress, the effective fastener stress field, is used directly for the fastener evaluation.

The system 100 can also support a wide variety of sort criteria at 3180. The criteria for sorting the fasteners can be evaluated from various points of view. Other sorting method/combination can be adapted. At 3180.02 the system 100 can sort the fasteners in descending order of the integral magnitude of the response over the period of the load. At 3180.04 fasteners can be sorted in descending order of the maximum magnitude of the response over the period of the load. At 3180.06 fasteners are sorted in descending order of the integral amplitude of the response over the frequency spectrum of the load. At 3180.08 fasteners are in descending order of the maximum amplitude of the response over the frequency spectrum of the load.

The effective stress at 3190 can be computed at each Fastener Grid as required by the combination of stress criteria selected. Compute the sorting index for each fastener grid in accordance with the sorting criteria selected. Sort the fastener grids in descending order with reference to the computed sorting index.

Each fastener grid is subjected to the processing loop/thread at 3192. At 3192.02 an array index is assigned as a fastener grid rank. A fastener grid rank is assigned to each fastener grid after sorting the array of fastener grids.

Each fastener can be subjected to the loop at 3194 for computing a rank for each fastener. At 3194.02, the system 100 collects the ranks of all the grids directly associated with the fastener. At 3194.04, the system 100 finds the maximum of the collected fastener grid ranks and assign the same as the fastener rank.

Each part can be subject to the loop at 3196 for computing the rank for each part from weld failure point of view. At 3196.02, the system 100 collects the ranks of all the fastener grids directly associated with the part. At 3196.04, the system 100 finds the maximum of the collected fastener grid ranks and assign the same as the part rank.

All sorting results can be saved into a database at 3198. The system 100 can sort the fasteners and parts in the descending order of their ranks. The system 100 can compare the fasteners and parts in an interactive graphical manner with various styles of presentation/display.

R. Fastener Degredation Evaluation

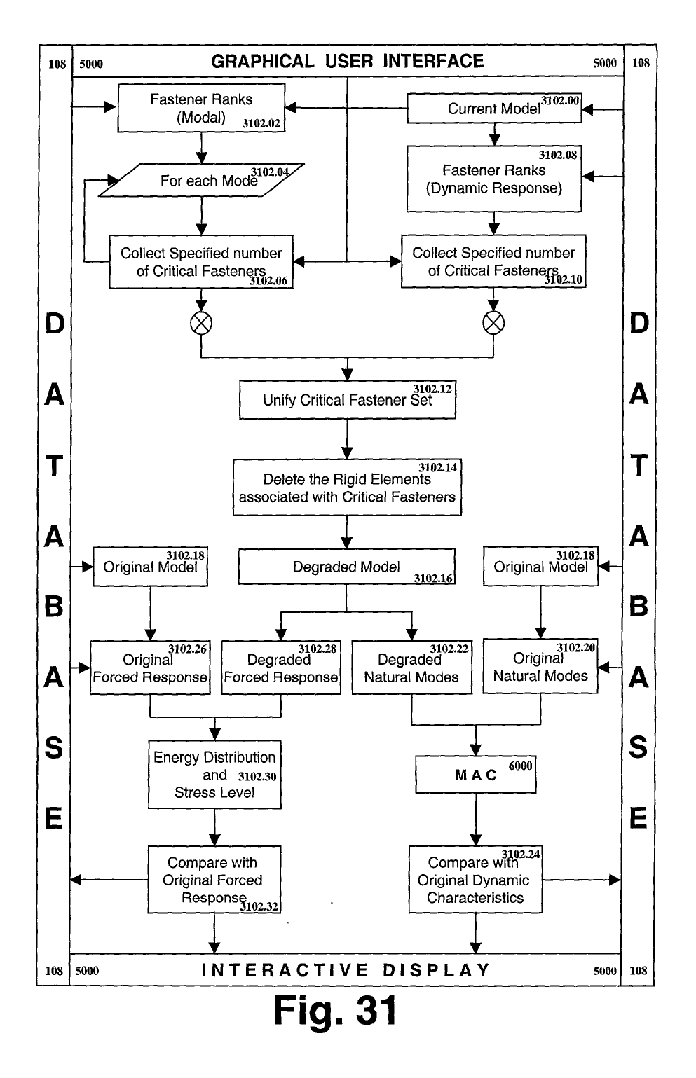

Part of the process for evaluating the critical locations can include degrading those locations and observing what the resulting effects are on the structure. FIG. 31 is a flow chart illustrating one example of a fastener degradation evaluation process that can be invoked by the system 100.

The process requires a model to be degraded at 3102.00. It could be design-enhanced model 188 (at 2600), a processed model 186 (1500). A sorted fastener list and the associated ranks generated at 3102.02 from the fastener evaluation (3110) with the modal response of the current model (3102.00). Critical fasteners of the current model (3102.00) can be collected from each mode.at 3102.04. At 3102.06, the system 100 sort the fasteners of the current model (3102.00) in the descending order for the current mode and collect the top critical (pre-specified in percentage or any other form) fasteners into the critical fastener set. At 3102.08, a sorted fastener list and the associated ranks are generated from the fastener evaluation (3110) with the dynamic response of the current model (3102.00). Critical fasteners of the current model (3102.00) are collected at 3103.10 from its dynamic response. Sort the fasteners of the current model (3102.00) in the descending order based on its dynamic response and collect the top critical (pre-specified in percentage or any other form) fasteners into the critical fastener set.

The various sets of critical fasteners can be merged at 3102.12. Duplicate references should be eliminated. Critical fasteners are identified at 3102.14 from the set of critical fasteners as identified at 3102.12. Mark the corresponding rigid elements for deletion from the current model (3102.00). A degraded model is then generated at 3102.16 by deleting the rigid elements that are associated with the critical fasteners. Fastener connection are deleted at the critical locations as identified at 3102.12. The system 100 can delete the associated rigid elements from the current model (3102.00) to create the degenerated model (3104). Part/element connectivity should be cleaned in the degenerated model. Solution sequences should be created for generating modal and dynamic responses for the degraded model 191.

If the degraded model is to be compared to other models, other models are required. The initial/processed model 186 can be a good candidate for such a comparison. An enhanced model 188 comparison should result in an even greater contrast. At 3102.20, the system 100 can extract the modal response for the original model 185 (3102.00) either from the built-in database or as an input from a built-in/external finite element solution. At 3102.22, the system 100 can generate the modal response for the degraded model (3104) from a built-in/external finite element solution. Read the modal response and store in the built-in database, if any.

The modal assurance criteria module 6000 can identify the modes of the degraded model 191 (3104) that correspond to the modes of the original model 185 (3102.00). The natural frequencies of the degraded model 191 (3104) can be compared at 3102.24 with that of the original model 185 (3102.00) for the corresponding modes and find the change in the frequencies for each mode. The system 100 can find the drop in different frequencies and assess the model degradation in terms of drop in the structural frequencies.

The dynamic response for the original model 185 (3102.00) can be extracted at 3102.26 either from the built-in database or as an input from a built-in/external finite element solution. The dynamic response for the degraded model 191 (3104) can be generated at 3102.28 from a built-in/external finite element solution. Read the dynamic response and store in the built-in database, if any. The system 100 can compute the energy and stress distribution, particularly in the vicinity of the fasteners for the degraded model (3104). The critical failure stress and life can also be determined for each fastener.

The system 100 can compare the critical failure stress and life of the degraded model (3104) with that of the original model (3102.00) at 3102.32. Assess the model degradation in terms of the drop in critical fastener failure life as well as the increase in the critical fastener failure stress.

S. Fastener Upgrade Evaluation

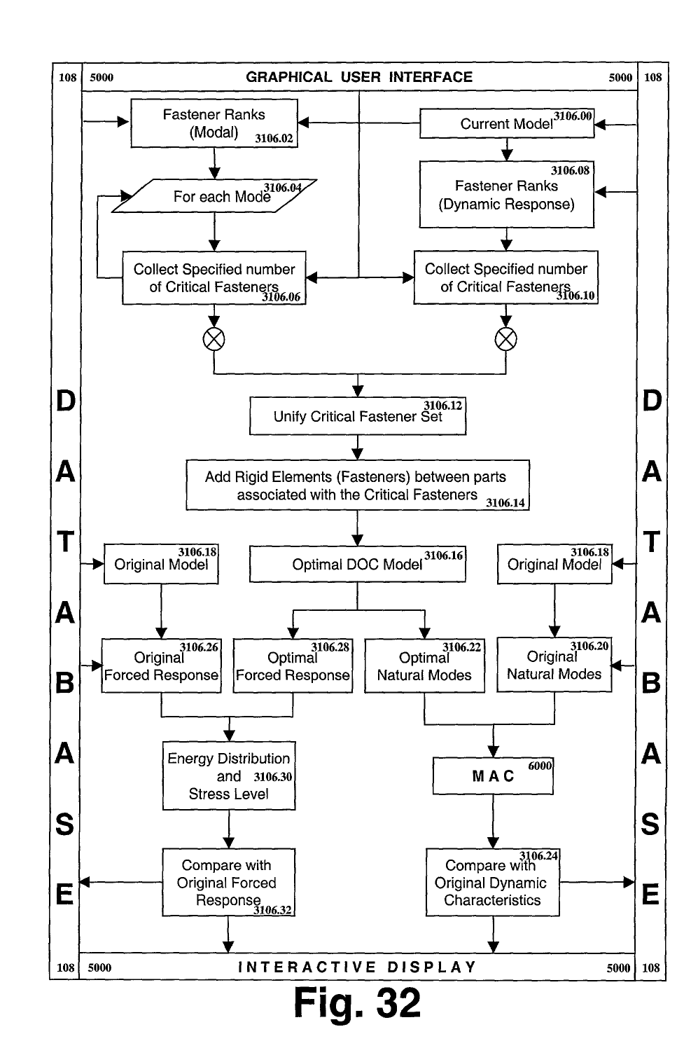

FIG. 32 is a flowchart that discloses an example of restored or upgraded model that can be compared to the other models saved in the database 108.

At 3106.00, the current model under consideration for fastener evaluation is sent to the fastener ranks (modal) at 3106.02. The current model 120 can be a design enhanced model or an initial/processed model capable of being processed by the system 100.

At 3106.02 a sorted fastener list and the associated ranks from the fastener evaluation with the modal response of the current model is created. At 3106.03 the system 100 collects the critical fasteners of the current model (3106) from each mode. At 310.06 the fasteners of the current model are sorted in descending order for the current mode. The top critical (pre-specified in percentage or by some other threshold) fasteners are collected into the critical fastener set. At 3106.08 the fastener list is sorted and the associated ranks are generated from the fastener evaluation (3110) with the dynamic response of the current model (3106.00).

Critical fasteners from the current model (3106.00) are collected at 3106.10 from its dynamic response. Fasteners of the current model (3106.00) are sorted in the descending order based on its dynamic response and collect the top critical (pre-specified in percentage or any other form) fasteners into the critical fastener set.

The sets of critical fasteners are merged at 3106.12. Duplicate references should be eliminated. The critical fasteners are identified at 3106.14 from the set of critical fasteners as identified at 3106.12. The system 100 marks the corresponding fastener areas 140 from the current model (3106.00) for appropriate reinforcement.

The density of fasteners is increased at 3106.16 in the identified critical fastener areas. Rigid elements are cleaned to represent the new fasteners resulting in the up-graded model (3108). The part/element connectivity characteristics are cleaned in the up-graded model. Solution sequences are created for generating modal and dynamic responses for the up-graded model.

For the purposes of comparison, another model is required at 3106.18. This is preferably the current model (3106), but other models could be compared by the system 100. The modal responses for the original model (3106.00) can be extracted at 3106.20 either from the built-in database or as an input from a built-in/external finite element solution.

The modal response is generated at 3106.22 for the degraded model (3108) from a built-in/external finite element solution. The system 100 can read the modal response and store in the built-in database 108, if any.

A standard Modal Assurance Criteria (MAC) module 6000 can be used to identify the modes of the up-graded model (3108) that correspond to the modes of the original model (3106.00).

The natural frequencies of the up-graded model (3108) are compared at 3106.24 with that of the original model (3106.00) for the corresponding modes and find the change in the frequencies for each mode. The system 100 will find the increase in different frequencies and assess the model up-gradation in terms of increase in the structural frequencies.

At 3106.26, the system 100 extracts the dynamic response for the original model (3106.00) either from the built-in database or as an input from a built-in/external finite element solution.

At 3106.28, the system 100 generates the dynamic response for the up-graded model (3108) from a built-in/external finite element solution. Read the dynamic response and store in the built-in database 108, if any.

At 3106.30, the system 100 can compute the energy and stress distribution, particularly in the vicinity of the fasteners for the up-graded model (3108). The critical failure stress and life should be computed at each fastener.

The critical failure stress and life of the up-graded model (3108) are compared at 3106.32 with that of the original model (3106.00). Assessing the model up-gradation in terms of the increase in critical fastener failure life as well as the decrease in the critical fastener failure stress is a preferred process.

VI. Alternative Embodiments

Although a few exemplary embodiments of this invention have been described in detail above, those skilled in the art will appreciate that many modifications are possible in the exemplary embodiments without materially departing from the novel teachings and advantages of this invention. The system 100 can incorporate a wide variety of different subsystems, modules, models, components, characteristics, location types, calculations, and various processes. Accordingly, all such modifications are intended to be included within the scope of this invention as defined in the following claims, which should be construed as broadly as the prior art will allow. Moreover, the headings included herein are for the convenience of the reader and should not be construed in any manner that would limit the scope of the claimed invention.

What is claimed is:

1. An enhancement system, comprising:
a model subsystem, comprising an analytical model comprising:
a plurality of initial characteristics; and
a plurality of locations with at least one said initial characteristic; and
a structural dynamic characteristics enhancement subsystem, comprising:
an interesting location selectively identified from said plurality of locations; and
an enhanced characteristic generated from said initial characteristic at said interesting location.

2. The system of claim 1, wherein the analytical model represents an assembly that does not physically exist.

3. The system of claim 1, wherein said analytical model is generated within said system.

4. The system of claim 1, wherein said analytical model is imported from a finite element analyzer.

5. The system of claim 4, wherein said analytical model provides for importing a plurality of dynamic load information in a plurality of formats, said plurality of formats comprising a time-history format, a magnitude-phase format, a real-imaginary format, and a power spectral density format.

6. The system of claim 1, further comprising a part and a set of structural parameters, wherein said part is represented by a set of elements corresponding to a set of structural parameters, and wherein said interesting location is said part.

7. The system of claim 1, further comprising a binding volume, wherein said interesting location is determined by said binding volume.

8. The system of claim 1, further comprising a binding volume, a plurality of elements, and a plurality of parts, wherein said interesting location is determined by a said plurality of elements from said plurality of parts within said binding volume.

9. The system of claim 1, further comprising a zone, wherein said interesting location is a zone.

10. The system of claim 1, further comprising a zone and a plurality of parts, wherein said zone is represented by a set of elements at least partially corresponding to one or more said parts, and wherein said interesting location is said zone.

11. The system of claim 1, further comprising a part set location, wherein said interesting location is a part set location.

12. The system of claim 1, further comprising a fastener location, wherein said interesting location is a fastener location.

13. The system of claim 1, said model subsystem further comprising a model cleanup component and an original model;
wherein said analytical model is generated from said original model by said model cleanup component.

14. The system of claim 13, said original model comprising interdependency data, wherein said model cleanup component resolves said interdependency data.

15. The system of claim 1, further comprising a plurality of interesting locations wherein each interesting location comprises a plurality of characteristics, and wherein a plurality of enhanced characteristics are generated from said plurality of characteristics.

16. The system of claim 15, wherein one said enhanced characteristic is generated for each said characteristic relating to each said interesting location.

17. The system of claim 1, further comprising an optimization subsystem and an optimized model, said optimized model generated from said analytical model and said enhanced characteristic by said optimization subsystem.

18. The system of claim 1, further comprising a plurality of interesting locations, a plurality of critical locations, and a plurality of enhanced characteristics, wherein only a subset of interesting locations are selectively identified as critical locations, and wherein said enhanced characteristics are only generated at said critical locations.

19. The system of claim 18, wherein the number of critical locations is controlled by a user interface.

20. The system of claim 1, said structural dynamic characteristics enhancement subsystem further comprising a fastener enhancement subsystem, wherein said interesting location is a fastener location and said enhanced characteristic is an enhanced fastener characteristic.

21. The system of claim 20, wherein said fastener is a weld.

22. The system of claim 21, wherein said weld is a spot weld.

23. The system of claim 20, said fastener enhancement subsystem further comprising: a fastener layout module, a fastener neighborhood characteristic, a plurality of critical fastener locations;
said fastener layout module identifying said plurality of critical fastener locations with said fastener neighborhood characteristic and said enhanced fastener characteristic.

24. The system of claim 23, wherein said enhanced fastener characteristic is a fastener strength.

25. The system of claim 23, wherein said enhanced fastener characteristic is a fastener durability.

26. The system of claim 23, wherein said fastener enhancement subsystem further comprises a fastener degradation component and a degradation characteristic.

27. The system of claim 26, wherein said degradation characteristic is a stiffness.

28. The system of claim 26, wherein said degradation characteristic is a fastener strength.

29. The system of claim 26, wherein said degradation characteristic is a fastener lifespan.

30. The system of claim 1, said structural dynamic characteristics enhancement subsystem further comprising a component enhancement subsystem, wherein said interesting location is a design location and said enhanced characteristic is an enhanced component characteristic.

31. The system of claim 30, said structural dynamic characteristics enhancement subsystem further comprising an energy module and an enhanced energy characteristic, wherein said energy module generates said enhanced energy characteristic from said enhanced component characteristic.

32. The system of claim 31, wherein said energy module generates a structural eigen-value response solution.

33. The system of claim 31, wherein said energy module generates a structural forced frequency response solution.

34. The system of claim 31, wherein said energy module generates an energy distribution.

35. The system of claim 31, wherein said energy module generates an energy flow.

36. The system of claim 31, wherein said energy module generates an energy content characteristic and an energy distribution characteristic.

37. The system of claim 31, said structural dynamic characteristics enhancement subsystem further comprising a stress module and an enhanced stress characteristic, wherein said stress module generates said enhanced stress characteristic from said enhanced component characteristic.

38. The system of claim 37, wherein said stress module generates an eigen-value response solution

39. The system of claim 37, wherein said stress module generates a forced-frequency response solution.

40. The system of claim 37, wherein said stress module generates a stress distribution.

41. The system of claim 31, said structural dynamic characteristics enhancement subsystem further comprising a sensitivity module and an enhanced sensitivity characteristic, wherein said sensitivity module generates said enhanced sensitivity characteristic from said enhanced component attribute.

42. The system of claim 41, wherein said sensitivity module generates a structural optimization solution sequence.

43. The system of claim 31, said structural dynamic characteristics enhancement subsystem further comprising a plurality of enhanced component characteristics comprising an enhanced static component characteristic and an enhanced dynamic component characteristic.

44. The system of claim 1, said structural dynamic characteristics enhancement subsystem further comprising a ranking module and a ranked list of interesting locations, wherein said ranking module generates said ranked list of interesting locations from at least one said characteristic relating to each interesting location in said plurality of interesting locations.

45. The system of claim 1, further comprising a database and an interrupted database process with a point of interruption, wherein said database resumes processing after said processing interruption at the point of interruption.

46. The system of claim 1, further comprising a user interface module, a plurality of display formats, and an important display format, wherein said user interface module automatically selects said important display format from said plurality of display formats.

47. The system of claim 1, said analytical model further comprising an initial mass and an enhanced mass, wherein said enhanced mass is lower than said initial mass.

48. The system of claim 1, said analytical model further comprising an initial failure rate and an enhanced failure rate, wherein said enhanced failure rate is lower than said initial failure rate.

49. The system of claim 48, wherein said initial failure rate is an initial fastener failure rate and said enhanced failure rate is an enhanced fastener failure rate.

50. The system of claim 48, wherein said initial failure rate is an initial component failure rate and said enhanced failure rate is an enhanced design failure rate.

51 The system of claim 1, said analytical model further comprising an initial strength and an enhanced strength, wherein said enhanced strength is greater than said initial strength.

52. The system of claim 51, wherein said initial strength is an initial static strength and wherein said enhanced strength is an enhanced static strength.

53. The system of claim 51, wherein said initial strength is an initial dynamic strength and wherein said enhanced strength is an enhanced dynamic strength.

54. The system of claim 1, said analytical model further comprising an initial durability and an enhanced durability, wherein said enhanced durability is greater than said initial durability.

55. The system of claim 1, further comprising a stress distribution heuristic and an energy distribution heuristic, wherein said stress distribution heuristic and said energy distribution heuristic selectively identify said enhanced location from said plurality of interesting locations.

56. The system of claim 1, said structural dynamic characteristics enhancement subsystem further comprising an energy module, a stress module, a sensitivity module, a strength module, and a durability module.

57. The system of claim 1, said structural dynamic characteristics enhancement subsystem providing for a plurality of enhanced characteristics comprising an enhanced force characteristic and an enhanced strain characteristic.

58. An enhancement system for an analytical model representing a structural assembly, comprising:
an analytical model;
a component enhancement subsystem, comprising:
a plurality of component locations, comprising a subset of interesting component locations;
a plurality of component characteristics; and
an enhanced component characteristic;
wherein said component enhancement subsystem provides for selectively identifying said subset of interesting component locations from said plurality of component locations; and
wherein said component enhancement subsystem provides for generating an enhanced component characteristic for at least one said interesting component location; and
a fastener enhancement subsystem, comprising:
a plurality of fastener locations, comprising a subset of interesting fastener locations;
a plurality of fastener characteristics; and
an enhanced fastener characteristic;
wherein said fastener enhancement subsystem provides for selectively identifying said subset of interesting fastener locations from said plurality of fastener locations; and
wherein said fastener enhancement subsystem provides for generating an enhanced fastener characteristic for at least one said interesting fastener location.

59. The system of claim 58, wherein said component enhancement subsystem further comprises a sensitivity criteria module.

60. The system of claim 58, wherein said component enhancement subsystem further comprises an energy criteria module.

61. The system of claim 58, wherein said component enhancement subsystem further comprises a stress criteria module.

62. The system of claim 58, wherein said component enhancement subsystem further comprises a plurality of enhanced component locations.

63. The system of claim 58, wherein said fastener enhancement subsystem further comprises a life criteria module.

64. The system of claim 58, wherein said fastener enhancement subsystem further comprises a strength criteria module.

65. The system of claim 58, wherein said fastener enhancement subsystem further comprises a fastener degradation criteria module.

66. The system of claim 58, wherein said fastener enhancement subsystem further comprises a neighborhood analysis module.

67. The system of claim 58, wherein said plurality of fastener locations comprises a bolt location, a spring location, and a weld location.

68. The system of claim 58, wherein said fastener enhancement subsystem further comprises a plurality of enhanced fasteners, said plurality of enhanced fasteners comprising: an enhanced bolt, an enhanced snap, and an enhanced weld.

69. The system of claim 58, further comprising an optimization subsystem for generating an optimized model from said analytical model, said enhanced component characteristic, and said enhanced fastener characteristic.

70. A method of enhancing a model, comprising:
identifying a subset of interesting locations from a plurality of locations on the analytical model;
evaluating the subset of interesting locations by evaluating one or more initial characteristics relating to each location in the subset of interesting locations; and
generating an enhanced model with enhanced dynamic characteristics by changing at least one initial characteristic into an enhanced characteristic for at least one interesting location.

71. The method of claim 70, wherein the initial characteristic is a modal solution.

72. The method of claim 70, wherein the initial characteristic is a structural sensitivity.

73. The method of claim 70, wherein the initial characteristic is a transient response.

74. The method of claim 70, wherein the initial characteristic is an energy analysis.

75. The method of claim 70, wherein the initial characteristic is a sensitivity analysis.

76. The method of claim 70, wherein the initial characteristic is a stress analysis.

77. The method of claim 70, wherein the initial characteristic comprises a model solution, a structural sensitivity, a transient response, an energy analysis, a sensitivity analysis, and a stress analysis.

78. The method of claim 70, wherein the initial characteristic is a life evaluation.

79. The method of claim 70, wherein the initial characteristic is a failure evaluation.

80. The method of claim 70, wherein the initial characteristic is a fastener neighborhood analysis.

81. The method of claim 70, further comprising comparing an enhanced model to the analytical model.

82. The method of claim 70, wherein a user determines the number of interesting locations.

83. The method of claim 70, wherein a user determines the number of initial characteristics calculated for each interesting location.

84. The method of claim 70, wherein a user-interface controls the types of interesting locations.

85. The method of claim 70, wherein a computer automatically determines the type of plots used to display enhancement data.

86. The method of claim 85, wherein a computer automatically determines the sequence in which plots are displayed.

87. The method of claim 85, further comprising setting predefined rules for initial characteristics and enhanced characteristics.

88. The method of claim 70, further comprising determining a critical location from the subset of interesting locations.

89. The method of claim 70, further comprising determining a plurality of critical locations from the subset of interesting locations.

90. The method of claim 70, further comprising ranking each interesting point in accordance with at least one initial characteristic relating to the interesting point.

91. The method of claim 70, further comprising ranking each interesting point in accordance with respect to all initial characteristics relating to the interesting point.

92. The method of claim 70, further comprising comparing a degraded model with an enhanced model.
